(19) United States
(12) Patent Application Publication
(10) Pub. No.: US 2025/0365282 A1
(43) Pub. Date: Nov. 27, 2025

(54) ONE TIME VOICE PASSPHRASE TO PROTECT AGAINST MAN-IN-THE-MIDDLE ATTACK

(71) Applicant: PINDROP SECURITY, INC., Atlanta, GA (US)

(72) Inventors: Amit GUPTA, Atlanta, GA (US); MohammedAli MERCHANT, Atlanta, GA (US); Vijay BALASUBRAMANIYAN, Atlanta, GA (US)

(73) Assignee: PINDROP SECURITY, INC., Atlanta, GA (US)

(21) Appl. No.: 19/216,469

(22) Filed: May 22, 2025

Related U.S. Application Data
(60) Provisional application No. 63/650,979, filed on May 23, 2024.

(51) Int. Cl. H04L 9/40; G10L 17/00

(52) U.S. Cl. CPC H04L 63/0861; G10L 17/00; H04L 63/0838

(57) ABSTRACT

Embodiments described herein provide for automatically authenticating operation requests and end-users who submit operation requests during contact events. A server obtains an operation request for an operation originated at an end-user device. The server generates a voice-based one-time password (OTP) using contextual information associated with the requested operation. The server generates and transmits an OTP prompt having text representing the OTP for display at a user interface of the user device. The server receives a response including an audio signal that contains the recording of the user speaking the OTP text aloud. The server uses the audio signal to authenticate the user and the operation request based on the speaker's voice, the accuracy of the user speaking the OTP, and liveness or fraud detection features extracted from the audio signal or metadata from the user device.

### CROSS-REFERENCE TO RELATED APPLICATIONS

This application claims the benefit of priority to U.S. Provisional Application No. 63/650,979, filed May 23, 2024, which is incorporated by reference in its entirety.

### TECHNICAL FIELD

This application generally relates to systems and methods for authenticating calling devices or callers originating telephone calls to call centers.

### BACKGROUND

As the sophistication of threats that target sensitive data and critical systems grows, the importance of robust security mechanisms becomes even more important. Identity verification is a key requirement to ensure that a request that claims to come from a certain source indeed does come from that source. Caller identification is a service provided by telephone carriers to transmit the phone number and/or the name of a caller to a callee. However, with the convergence of IP (Internet protocol) and telephony, it is easier to spoof caller identification (e.g., caller's number and/or name) without being detected by the callee.

Conventional and existing methods for verifying a user's identification (ID) may be cumbersome and tedious. For example, some conventional methods use knowledge-based questions to authenticate users. A caller trying to access a service, such as a financial institution, by making a phone call may have to answer some questions regarding private information to confirm the caller's identity. Such conventional methods may be insecure, inefficient, cumbersome, and take too much time to verify the identity of the user. In addition, such conventional methods may require the user to perform various actions that result in negative user experience. Some solutions have proposed including a mobile application installed on the mobile device that would exchange information about the user and/or device with the enterprise.

Another complication is that using information received during the telephone call, either through conversation with an agent or through caller interactions with an interactive voice response (IVR) system, is that the telephone communication channel is growing increasingly untrustworthy as techniques for exploiting vulnerabilities, including spoofing information and social engineering, grow more sophisticated.

Common types of fraud exploits or attacks allow for fraudsters or other bad actors to capture information about genuine users that can be used to get access to user information or authorize fraudulent actions (e.g., reset passwords, initiate funds transfers). One type of attack is simple social engineering in which a bad actor tricks the genuine users or service providers to provide confidential information or access credentials. There are many technological solutions to protect confidential information against various types of attacks. But the bad actors may employ technological attacks, such as a man-in-the-middle attack, in which a fraudster inserts themselves into the communication stream between the service provider and the genuine user, allowing the fraudster to view data traffic and capture confidential information, such as access credentials or other sensitive information.

### SUMMARY

Disclosed herein are systems and methods capable of addressing the above-described shortcomings and may also provide any number of additional or alternative benefits and advantages. Embodiments described herein provide for automatically authenticating operation requests and end-users who submit operation requests during contact events. A server obtains an operation request for an operation originated at an end-user device. The server generates a voice-based one-time password (OTP) using contextual information associated with the requested operation. The server generates and transmits an OTP prompt having text representing the OTP for display at a user interface of the user device. The server receives a response including an audio signal that contains the recording of the user speaking the OTP text aloud. The server uses the audio signal to authenticate the user and the operation request based on the speaker's voice, the accuracy of the user speaking the OTP, and liveness or fraud detection features extracted from the audio signal or metadata from the user device.

In embodiments, the techniques described herein relate to a computer-implemented method for authentication using one-time passwords (OTPs), the method including: obtaining, by a computer, an operation request indicating an operation that originated at an inbound user device associated with an inbound user; generating, by the computer, an OTP for the operation request based upon operation information associated with the operation obtained from the inbound user device; generating, by the computer, an OTP prompt having text representing the OTP for display at a user interface of the inbound user device; transmitting, by the computer, an OTP request associated with the operation request to the inbound user device, the OTP request including the OTP prompt; generating, by the computer, a speaker recognition score based upon an inbound voiceprint extracted for an inbound audio signal representing a spoken audio response of an OTP response from the inbound user and an enrolled voiceprint associated with an enrolled user; and authenticating, by the computer, the operation request based upon the speaker recognition score and a content recognition score.

The method may include determining, by the computer, that the operation request indicates a type of secure operation. The computer generates the OTP in response to determining that the operation request indicates the type of secure operation.

The method may include determining, by the computer, an operation request risk score for the operation request, wherein the computer generates the OTP in response to determining that the operation request risk score satisfies a request risk threshold. The computer may generate the OTP according to at least a portion of the operation information received from an agent device.

The method may include generating, by the computer, response content text of the OTP response from the inbound user device by applying an automatic speech recognition (ASR) engine on the inbound audio signal; and generating, by the computer, a response content score based upon the text of the OTP and the response content text.

The method may include extracting, by the computer, the inbound voiceprint using a plurality of speaker acoustic features of the inbound audio signal.

The method may include extracting, by the computer, one or more inbound fakeprints using a plurality acoustic features of the inbound audio signal; and generating, by the computer, one or more liveness scores for the operation request using one or more enrolled fakeprints.

The method may include extracting, by the computer, one or more fakeprints using metadata obtained in the OTP response from the inbound user device; and generating, by the computer, one or more liveness scores for the operation request using one or more enrolled fakeprints.

The method may include transmitting, by the computer, an authentication result based upon authenticating the operation request to an agent device.

Generating the speaker recognition score may include determining, by the computer, a distance between the inbound voiceprint and the enrolled voiceprint.

In embodiments, the techniques described herein relate to a system for authentication using one-time passwords (OTPs), the system including: a computer including at least one processor, configured to: obtain an operation request indicating an operation that originated at an inbound user device associated with an inbound user; generate an OTP for the operation request based upon operation information associated with the operation obtained from the inbound user device; generate an OTP prompt having text representing the OTP for display at a user interface of the inbound user device; transmit an OTP request associated with the operation request to the inbound user device, the OTP request including the OTP prompt; generate a speaker recognition score based upon an inbound voiceprint extracted for an inbound audio signal representing a spoken audio response of an OTP response from the inbound user and an enrolled voiceprint associated with an enrolled user; and authenticate the operation request based upon the speaker recognition score and a content recognition score.

The computer may be further configured to determine that the operation request indicates a type of secure operation, and wherein the computer generates the OTP in response to determining that the operation request indicates the type of secure operation.

The computer may be further configured to determine an operation request risk score for the operation request. The computer generates the OTP in response to determining that the operation request risk score satisfies a request risk threshold. The computer may generate the OTP according to at least a portion of the operation information received from an agent device.

The computer may be further configured to generate response content text of the OTP response from the inbound user device by applying an automatic speech recognition (ASR) engine on the inbound audio signal; and generate a response content score based upon the text of the OTP and the response content text.

The computer may be further configured to extract the inbound voiceprint using a plurality of speaker acoustic features of the inbound audio signal.

The computer may be further configured to: extract one or more inbound fakeprints using a plurality of acoustic features of the inbound audio signal; and generate one or more liveness scores for the operation request using one or more enrolled fakeprints.

The computer may be further configured to: extract one or more fakeprints using metadata obtained in the OTP response from the inbound user device; and generate one or more liveness scores for the operation request using one or more enrolled fakeprints.

The computer may be further configured to transmit an authentication result based upon authenticating the operation request to an agent device. When generating the speaker recognition score the computer may be further configured to determine a distance between the inbound voiceprint and the enrolled voiceprint. Authenticating a User from Their OTP Response

In embodiments, the techniques described herein relate to a computer-implemented method for authentication using one-time passwords (OTPs), the method including: receiving, by a computer, an OTP response from an inbound user device associated with an operation request, the OTP response having an inbound audio signal including a spoken audio response of an inbound user associated with the inbound user device; generating, by the computer, response content text based upon the spoken audio response of the inbound audio signal; extracting, by the computer, an inbound voiceprint using the inbound audio signal and representing the spoken audio response of the OTP response of the inbound user; generating, by the computer, a speaker recognition score based upon the inbound voiceprint and an enrolled voiceprint associated with an enrolled user; generating, by the computer, a response content score based upon the response content text and OTP text of an OTP associated with the operation request; and authenticating, by the computer, the operation request based upon the speaker recognition score and the response content score.

The method may include obtaining, by the computer, the operation request indicating an operation that originated at the inbound user device associated with the inbound user; generating, by the computer, the OTP text of the OTP for the operation request based upon operation information associated with the operation request; and generating, by the computer, an OTP prompt having the OTP text for display at a user interface of the inbound user device. The computer generates the OTP according to at least a portion of the operation information received from an agent device.

The method may include transmitting, by the computer, an OTP request to the inbound user device, the OTP request including an OTP prompt for displaying the OTP text at a user interface of the inbound user device.

Generating the speaker recognition score may include obtaining, by the computer, from a database the enrolled voiceprint for the enrolled user according to the operation request; and determining, by the computer, a distance as the speaker recognition score between the inbound voiceprint and the enrolled voiceprint. The method may include comparing, by the computer, the speaker recognition score against a speaker recognition threshold score.

Generating the response content score may include generating, by the computer, the response content text of the OTP response from the inbound user device by applying an automatic speech recognition (ASR) engine on the inbound audio signal; and comparing, by the computer, the response content score against a corresponding response OTP content threshold score.

The method may include extracting, by the computer, one or more inbound fakeprints using a plurality of acoustic features the inbound audio signal of the OTP response of the inbound user; and generating, by the computer, one or more liveness scores for the operation request based upon the one or more inbound fakeprints and one or more enrolled fakeprints.

The method may include extracting, by the computer, one or more fakeprints using metadata obtained in the OTP response from the inbound user device; and generating, by the computer, one or more liveness scores for the operation request using one or more enrolled fakeprints. The method may include transmitting, by the computer, an authentication result based upon authenticating the operation request to an agent device.

In embodiments, the techniques described herein relate to a system for authentication using one-time passwords (OTPs), the system including: a computer including at least one processor, configured to: receive an OTP response from an inbound user device associated with an operation request, the OTP response having an inbound audio signal including a spoken audio response of an inbound user associated with the inbound user device; generate response content text based upon the spoken audio response of the inbound audio signal; extract an inbound voiceprint using the inbound audio signal and representing the spoken audio response of the OTP response of the inbound user; generate a speaker recognition score based upon the inbound voiceprint and an enrolled voiceprint associated with an enrolled user; generate a response content score based upon the response content text and OTP text of an OTP associated with the operation request; and authenticate the operation request based upon the speaker recognition score and the response content score.

The computer may be further configured to: obtain the operation request indicating an operation that originated at the inbound user device associated with the inbound user; generate the OTP text of the OTP for the operation request based upon operation information associated with the operation request; and generate an OTP prompt having the OTP text for display at a user interface of the inbound user device. The computer may generate the OTP according to at least a portion of the operation information received from an agent device.

The computer may be further configured to transmit an OTP request to the inbound user device, the OTP request including an OTP prompt for displaying the OTP text at a user interface of the inbound user device.

When generating the speaker recognition score, the computer may be further configured to obtain from a database the enrolled voiceprint for the enrolled user according to the operation request; and determine a distance as the speaker recognition score between the inbound voiceprint and the enrolled voiceprint. The computer may be further configured to compare the speaker recognition score against a speaker recognition threshold score.

When generating the response content score, the computer may be further configured to generate the response content text of the OTP response from the inbound user device by applying an automatic speech recognition (ASR) engine on the inbound audio signal; and compare the response content score against a corresponding response OTP content threshold score.

The computer may be further configured to: extract one or more inbound fakeprints using a plurality of acoustic features the inbound audio signal of the OTP response of the inbound user; and generate one or more liveness scores for the operation request based upon the one or more inbound fakeprints and one or more enrolled fakeprints.

The computer may be further configured to: extract one or more fakeprints using metadata obtained in the OTP response from the inbound user device; and generate one or more liveness scores for the operation request using one or more enrolled fakeprints. The computer may be further configured to transmit an authentication result based upon authenticating the operation request to an agent device. Client-Side Operations (e.g., Client App)

In embodiments, the techniques described herein relate to a computer-implemented method for authentication using a voice-based one-time password (OTP), the method including: transmitting, by a computing device associated with an end-user, a message indicating an operation request to a backend server; receiving, by the computing device, an OTP request including an OTP prompt having OTP text of an OTP; displaying, by the computing device, the OTP text of the OTP prompt at a user interface of the computing device of the end-user; obtaining, by the computing device, an audio signal including a speaker audio signal of the end-user purportedly speaking the OTP; generating, by the computing device, an OTP response corresponding to the OTP request, the OTP response including the audio signal including the speaker audio signal; and transmitting, by the computing device, the OTP response to the backend server.

The method may further include receiving, by the computing device, an authentication result for the operation request from the backend server. The method may further include displaying, by the computing device, the authentication result for the operation request as received from the backend server.

The OTP response may further include metadata associated with the computing device of the end-user, the metadata including at least one of a user identifier of the end-user or a device identifier of the computing device. The OTP response may further include an operation request identifier associated with the operation request.

The computing device may transmit the message indicating the operation request via at least one of a telephony channel or a data channel. The computing device may receive the OTP request via at least one of a data channel or a telephony channel. The computing device may transmit the OTP response via at least one of a data channel or a telephony channel.

The computing device may include and execute a mobile application associated with the backend server. The computing device receives the OTP request as a push notification for the mobile application. The computing device may receive the OTP request containing the OTP prompt via at least one of a text message or an email message.

In embodiments, the techniques described herein relate to a system for authentication using a voice-based one-time password (OTP), the system including: a computing device associated with an end-user having at least one processor, the computing device configured to: transmit a message indicating an operation request to a backend server; receive an OTP request including an OTP prompt having OTP text of an OTP; display the OTP text of the OTP prompt at a user interface of the computing device of the end-user; obtain an audio signal including a speaker audio signal of the end-user purportedly speaking the OTP; generate an OTP response corresponding to the OTP request, the OTP response including the audio signal including the speaker audio signal; and transmit the OTP response to the backend server.

The computing device may be further configured to receive an authentication result for the operation request from the backend server. The computing device may be further configured to display the authentication result for the operation request as received from the backend server. The OTP response may further include metadata associated with the computing device of the end-user, the metadata including at least one of a user identifier of the end-user or a device identifier of the computing device. The OTP response may further include an operation request identifier associated with the operation request. The computing device may transmit the message indicating the operation request via at least one of a telephony channel or a data channel.

The computing device may receive the OTP request via at least one of a data channel or a telephony channel. The computing device may transmit the OTP response via at least one of a data channel or a telephony channel. The computing device may include and execute a mobile application associated with the backend server, and wherein the computing device receives the OTP request as a push notification for the mobile application. The computing device may receive the OTP request containing the OTP prompt via at least one of a text message or an email message.

It is to be understood that both the foregoing general description and the following detailed description are exemplary and explanatory and are intended to provide further explanation of the invention as claimed.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 shows components of an example system for analyzing and authenticating contact data received during contact events, according to example embodiments.

FIG. 2 shows components of a system for analyzing content event data and authentication, according to example embodiments.

FIG. 3 shows dataflow amongst components of an example system for authenticating end-user requested operations using voice-based OTPs, according to example embodiments.

FIG. 4 shows components of an example system for training operations of one or more neural networks architectures for spoof detection and speaker recognition, according to example embodiments.

FIG. 5 shows steps of a method for enrollment and deployment operations of one or more neural networks architectures for spoof detection and speaker recognition, according to example embodiments.

FIG. 6 shows operations of a computer-executed method for authentication using OTPs, according to embodiments.

FIG. 7 shows operations of a computer-executed method for authentication using OTPs, according to example embodiments.

FIG. 8 shows operations of computer-implemented method for authentication using a voice-based one-time password (OTP) at an end-user device, according to example embodiments.

### DETAILED DESCRIPTION

Reference will now be made to the illustrative embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to a person skilled in the relevant art and having possession of this disclosure, are to be considered within the scope of the invention.

Embodiments may generate an OTP passphrase for an end-user to speak aloud into a microphone associated with an end-user device. A computer generates the OTP based on various types of information, including context information gathered by the computer and related to, for example, a requested operation (e.g., reset user credentials, conduct transaction). The computer then generates an OTP prompt that is then transmitted to an end-user device and presented to the end-user that instructs the user to speak the OTP into the microphone. The computing system generates the OTP using contextually relevant information that establishes the complexity of OTP-based authentication, and transmits the OTP prompt for the end-user to speak.

Embodiments may authenticate an end-user based upon the end-user's OTP response. The computing system generates the OTP using the contextually relevant information and transmits the OTP prompt the end-user device. The computer receives the OTP response to the OTP prompt from the end-user device, allowing the computing system to authenticate the end-user based upon authenticating information in the OTP response, such as features of a speaker's voice and the content of the speech, among other types of information. The computer authenticates the user using multiple factors, such as the spoken content of the user's response, the voiceprint of the user, and liveness/spoofing detection, among other types of factors related to the speaker or the devices.

Embodiments may include software components (e.g., client app, web-app) executed at an end-user device for performing client-side operations. Such embodiments include the operations of a locally installed, client-side app on the end-user device that can handle authentication OTP requests from a computing system. The user's device may receive the OTP requests containing the OTP via various data formats and data channels, such as text messages (e.g., SMS, MMS), email, or directly within the client app. The client app may present the user with a user interface where the user reads aloud the OTP into the device's microphone, and the client app may capture and process this information. The client app may also capture various types of device-identifying metadata for authentication purposes. In some cases, the client app can perform certain preprocessing and/or authentication operations locally. The client app then forwards the user's OTP response having various types of related information to the backend computing system.

During a “contact event” between the end-user and a provider system, an end-user may request an operation that carries heightened risk (for example, a credential reset or a funds transfer). Examples of the contact event may include a phone call with an agent-user or interactive voice response (IVR) system, or live-chat session with an agent-user or chatbot, among others. Based on the operation request, the provider system invokes an out-of-band, voice-based one-time-password (“OTP”) workflow. In some cases, the provider system invokes the OTP operations automatically or in response to an instruction from an agent-user of the provider system, entered at a user interface of an agent device. Optionally, the provider system invokes the OTP operations for a certain type of operation request or in response to determining that the user's operation request exceeds a pre-defined risk threshold. An authentication service or analytics system associated with the provider server dynamically generates an authorization request, which includes generating a random or context-derived OTP and a corresponding OTP prompt for display at the user interface of the end-user device. The OTP prompt may display the OTP and instruct the user to read the OTP aloud. The analytics system may authenticate the end-user device and determine whether the provider system should trust the end-user's device and perform the operation request.

For instance, an agent associated with the provider organization launches a “verification request” in the authentication service's console. The request package includes the end-user's vetted delivery identifier (e-mail address or mobile number), the freshly-generated OTP, a concise statement explaining why additional verification is needed, and a challenge question tailored to the current transaction context. This information enables the downstream mobile experience to present multi-factor contextual information that the user should recognize.

As an example, the authentication system or the provider system transmits an OTP prompt as a notification containing a one-time link to the user's designated address or phone number. When the user taps or clicks the link, a lightweight browser-based web application opens and immediately displays: the identity of the requesting organization, the stated reason for verification, the context-specific question, and the OTP passphrase the user is asked to speak. Presenting the information in this manner gives the user clear context while preserving channel separation between the voice path (e.g., communication channel carrying voice audio signal data) and the data path (e.g., communication channel carrying data exchanges).

The user may enter an answer to the challenge question and, while the software of the end-user device records, speaks the displayed OTP. After a successful capture, the end-user uploads or transmits the recorded audio together with the typed response to the authentication service as an OTP response from the end-user.

On the backend, the analytics system (or a service provider system) matches an operation request identifier to the correct user record, performs one or more evaluations, such as matching the spoken OTP response to the expected OTP of the OTP prompt, matching an inbound voiceprint against an enrolled voiceprint of a registered enrolled end-user, and running a liveness analysis to rule out synthetic or replayed speech. The authentication system may transmit individual and/or aggregate results to the agent's console in near-real time. If any factor fails or if the user does not act within a configurable validity window (e.g., two minutes), the operation request expires and the operation request is blocked or escalated.

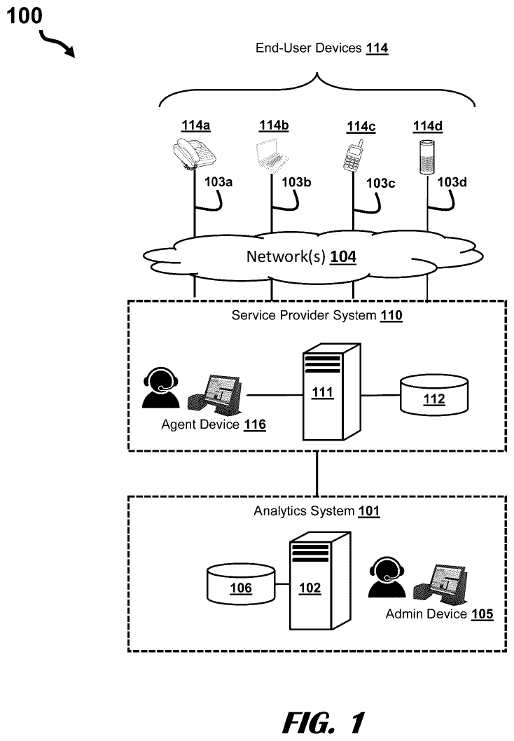

FIG. 1 shows components of an example system 100 for shows components of a system 100 for analyzing and authenticating contact data received during contact events. The system 100 comprises any number of end-user devices 114a-114d (collectively referred to as “end-user devices 114” or an “end-user device 114”) and enterprise infrastructures 101, 110, including an analytics system 101 and one or more service provider systems 110. The analytics system 101 includes analytics servers 102, analytics databases 106, and admin devices 105. The service provider systems 110 may include provider servers 111, provider databases 112, and agent devices 116. The various hardware and software components of the system 100 may communicate with one another via one or more networks 104, through various types of communication channels 103a-103d (collectively referred to as “channels 103” or a “channel 103”).

Embodiments may comprise additional or alternative components or omit certain components from those of FIG. 1 and still fall within the scope of this disclosure. As an example, it may be common for the system 100 to include multiple service provider systems 110 or the analytics system 101 to include multiple analytics servers 102. Embodiments may include or otherwise implement any number of devices capable of performing the various features and tasks described herein. For example, the system 100 of FIG. 1 shows the analytics server 102 as a distinct computing device from the analytics database 106, though in some embodiments, the analytics database 106 may be integrated into the analytics server 102.

The one or more networks 104 of the system 100 includes various hardware and software components of one or more public or private networks that interconnect the various components of the system 100 and host or conduct audio and voice communications originated at the end-user devices 114. Non-limiting examples of such networks 104 may include: Local Area Network (LAN), Wireless Local Area Network (WLAN), Metropolitan Area Network (MAN), Wide Area Network (WAN), and the Internet. The communications over the network 104 may be performed in accordance with various communication protocols, such as Transmission Control Protocol and Internet Protocol (TCP/IP), User Datagram Protocol (UDP), and IEEE communication protocols. Likewise, the end-user devices 114 may communicate with callees (e.g., provider systems 110) via telephony and telecommunications protocols, hardware, and software of the networks 104, capable of hosting, transporting, and exchanging audio data associated with telephony-based calls. Non-limiting examples of telecommunications hardware of the networks 104 may include switches and trunks, among other additional or alternative hardware used for hosting, routing, or managing telephone calls, circuits, and signaling. Non-limiting examples of software and protocols of the networks 104 for telecommunications may include SS7, SIGTRAN, SCTP, ISDN, and DNIS among other additional or alternative software and protocols used for hosting, routing, or managing telephone calls, circuits, and signaling. Various different entities manage or organize the components of the telecommunications systems of the networks 104, such as carriers, networks, and exchanges, among others.

The end-user devices 114 (sometimes referred to as “caller devices”) may be any communications or computing devices that the caller operates to access the services of the service provider system 110 through the various communications channels 103. The end-user may place the call to the service provider system 110 through a telephony network or through a software application executed by the end-user device 114. Non-limiting examples of end-user devices 114 may include landline phones 114a, mobile phones 114c, computing devices 114b, or edge devices 114d. The landline phones 114a and mobile phones 114c are telecommunications-oriented devices (e.g., telephones) that communicate via certain channels 103 for telecommunications. The end-user devices 114, however, are not limited to the telecommunications-oriented devices or channels. For instance, in some cases, the mobile phones 114c may communicate via channels 103 for computing network communications (e.g., the Internet). The end-user device 114 may also include an electronic device comprising at least one processor and/or software, such as a computing device 114b or edge device 114d implementing, for example, voice-over-IP (VOIP) telecommunications, data streaming via a TCP/IP network, or other computing network channel. The edge device 114d may include any Internet of Things (IoT) device or other electronic device for computing network communications. The edge device 114d could be any smart device capable of executing software applications and/or performing voice interface operations. Non-limiting examples of the edge device 114d may include voice assistant devices, automobiles, smart appliances, and the like.

As described herein, the analytics system 101 or service provider systems 110 may receive calls or other forms of contact events from the end-user devices 114 via one or more communications channels 103, which include various forms of communication channels 103 for contact events conducted over the one or more networks 104. The channels 103 facilitate communications between the provider system 110 and the end-user device 114, whenever the user accesses and interacts with the services or devices of the provider system 110 and exchanges various types of data or executable instructions. The channels 103 allow the end-user to access the services, service-related data, and/or user account data hosted by components of the provider system 110, such as the provider servers 111. Each channel 103 includes hardware and/or software components for hosting and conducting the communication exchanges for contact events (e.g., telephone calls, online interactions) between the provider system 110 and the end-user device 114 corresponding to the channel 103.

In some cases, the user operates a telephony communications device, such as a landline phone 114a or mobile device 114c, to interact with services of the provider system 110 by placing a telephone call to a call center agent or interactive voice response (IVR) system hosted by the enterprise telephony server 111a. The user operates the telephony device (e.g., landline phone 114a, mobile device 114c) to access the services of the provider system 110 via corresponding types of telephony communications channels, such as the landline channel 103a (for the landline phone 114a) or the mobile telephony channel 103c (for the mobile device 114c).

In some cases, the end-user device 114 includes a data-centric computing device (e.g., computing device 114b, mobile device 114c, IoT device 114d) that the user operates to place a call (e.g., VoIP call) to or access the services of the provider system 110 through a data-centric channel 103 (e.g., computing channel 103b, mobile channel 103c, IoT channel 103d), which includes hardware and software of computing data networks and communication (e.g., Internet, TCP/IP networks). For instance, the user operates the computing device 114b or IoT device 114d as a telephony device that executes software-based telephony protocols (e.g., VOIP) to place a software-based telephony call through the corresponding channel (e.g., computing channel 103b, IoT channel 103d) to the provider server 111 or analytics server 102. Notably, certain channels 103 of the system 100 represent data channels in some circumstances, but represent telephony channels in other cases. For example, the end-user executes software on the computing device 114b that accesses a web-portal or web-application hosted on the provider server 111, such that the computing channel 103b represents a data-centric channel carrying the data packets for the data service-related services. As another example, the end-user executes a telephony software (sometimes referred to as a “softphone”) of the computing device 114b or mobile device 114c to place a telephone call received at the provider server 111, such that the computing channel 103b or mobile channel 103b represents a telephony channel carrying the data for the telephony-related services.

The analytics system 101 and the provider system 110 represent network infrastructures 101, 110 comprising physically and logically related software and electronic devices managed or operated by various enterprise organizations. The hardware and software components of each network system infrastructure 101, 110 are configured to provide the intended services.

An enterprise organization (e.g., corporation, government entity, university) operates the service provider system 110 accessible to the end-user devices 114. The provider system 110 includes hardware and software components to, for example, service contact events, such as telephone calls or web-based interactions, with the end-users and end-user devices 114 via the various communication channels 103. The service provider system 110 includes provider server 111 or other computing device that executes various operations related managing inbound contact data, such as telephone calls or web-based data packets. For instance, these operations include receiving or generating various forms of contact data and transmitting the contact data to the analytics system 101. At the analytics system 101, the analytics server 102 performs the analytics operations on the contact data to, for example, identify a level of fraud risk or authenticate the end-user or end-user device 114.

The components of the analytics system 101 perform various analytics operations on behalf of the enterprise's service provider system 110 for the contact data received at the provider system 110. The analytics operations include, for example, fraud detection and caller authentication. The service provider system 110 comprises various hardware and software components that capture and store various types of contact data (sometimes referred to as “call data” in the example system 100), including audio data or metadata related to the call or other type of contact event received at the service provider system 110. The data may include, for example, audio data (e.g., audio recording, audio segments, acoustic features), caller inputs (e.g., DTMF keypress tones, spoken inputs or responses), caller information, and metadata (e.g., protocol headers, device identifiers) related to particular software applications (e.g., Skype), programming standards (e.g., codecs), and protocols (e.g., TCP/IP, SIP, SS7) used to execute the call via the particular communication channel 103 (e.g., landline telecommunications, cellular telecommunications, Internet). The service provider system 110 is operated by a particular enterprise to offer various services to the enterprise's end-users (e.g., customers, account holders).

The analytics server 102 of the analytics system 101 may evaluate the contact data to, for example, determine fraud risks associated with the contact events (e.g., inbound calls), or authenticate the contact events (e.g., inbound calls). When authenticating a particular contact event, the analytics server 102 may authenticate the end-user or the end-user device 114.

The analytics server 102 may be any computing device comprising one or more processors (or at least one processor) and software, and capable of performing the various processes and tasks described herein. The analytics server 102 may host or be in communication with the analytics database 106, and receives and processes the contact data (e.g., audio recordings, telephony metadata, TCP/IP data packets, TCP/IP metadata) received from the one or more service provider system 110. Although FIG. 1 depicts a single analytics server 102, the analytics server 102 may include any number of computing devices. In some cases, the computing devices of the analytics server 102 may perform all or sub-parts of the processes and functions of the analytics server 102. The analytics server 102 may comprise computing devices operating in a distributed or cloud computing configuration and/or in a virtual machine configuration. It should also be appreciated that, in some embodiments, functions of the analytics server 102 may be partly or entirely performed by the computing devices of the service provider system 110 (e.g., provider servers 111).

When the provider server 111 (e.g., enterprise telephony server 111a) receives contact data from the end-user device 114 during a contact event (e.g., call via channel 103 for carrying telephony communications), the provider server 111 transmits an analytics request or authentication request to the analytics server 102, instructing the analytics server 102 to invoke various analytics operations on the call data received from the end-user device 114 for a given communication channel session (e.g., inbound call received via telephony channel). The analytics server 102 executes software programming for generating a one-time passphrase (OTP) and transmitting OTP prompts, analyzing contact event data (e.g., call data, OTP responses to OTP prompts) for end-user authentication and fraud risk scoring.

The software programming of the analytics server 102 includes machine-learning software routines organized as a machine-learning architecture having various one or more models or functions defining operational engines and/or components of the machine-learning architecture. The software routines may define the machine-learning layers of the machine-learning models of the machine-learning architecture and sub-components of the machine-learning architecture (e.g., machine-learning models, sub-architectures), such as a Gaussian Mixture Matrix (GMM), neural network (e.g., convolutional neural network (CNN), deep neural network (DNN)), and the like. The machine-learning architecture may include functions, layers, parameters, and weights for performing the various operations discussed herein, including computing keypress features, extracting embeddings (e.g., voiceprints, spoofprints or fakeprints, device-prints, behavior-prints), and end-user authentication or fraud risk scoring. Certain operations may include, for example, authentication (e.g., user authentication, speaker authentication, end-user device 114 authentication), end-user recognition, and risk detection, among other operations.

In some implementations, for instance, the software functions of the analytics server 102 includes machine-learning models, functions, or layers for generating and analyzing various types of feature vector embeddings, including voiceprints and fakeprints (sometimes referred to as “spoofprints”), among others. The analytics server 102 executes audio-processing software that includes a neural network that performs speaker spoof detection, among other potential operations (e.g., speaker recognition, speaker verification or authentication, speaker diarization). The neural network architecture operates logically in several operational phases, including a training phase, an enrollment phase, and a deployment phase (sometimes referred to as a test phase or testing). The inputted audio signals processed by the analytics server 102 include training audio signals, enrollment audio signals, and inbound audio signals processed during the deployment phase. The analytics server 102 applies the neural network to each of the types of inputted audio signals during the corresponding operational phase.

The analytics server 102 or other computing device of the system 100 (e.g., provider server 111) can perform various pre-processing operations and/or data augmentation operations on the input audio signals. Non-limiting examples of the pre-processing operations include extracting low-level features from an audio signal, parsing and segmenting the audio signal into frames and segments and performing one or more transformation functions, such as Short-time Fourier Transform (SFT) or Fast Fourier Transform (FFT), among other potential pre-processing operations. Non-limiting examples of augmentation operations include audio clipping, noise augmentation, frequency augmentation, duration augmentation, and the like. The analytics server 102 may perform the pre-processing or data augmentation operations before feeding the input audio signals into input layers of the neural network architecture or the analytics server 102 may execute such operations as part of executing the neural network architecture, where the input layers (or other layers) of the neural network architecture perform these operations. For instance, the neural network architecture may comprise in-network data augmentation layers that perform data augmentation operations on the input audio signals fed into the neural network architecture.

During training, the analytics server 102 receives training audio signals of various lengths and characteristics from one or more corpora, which may be stored in an analytics database 106 or other storage medium. The training audio signals include clean audio signals (sometimes referred to as samples) and simulated audio signals, each of which the analytics server 102 uses to train the neural network to recognize speech occurrences. The clean audio signals are audio samples containing speech in which the speech is identifiable by the analytics server 102. Certain data augmentation operations executed by the analytics server 102 retrieve or generate the simulated audio signals for data augmentation purposes during training or enrollment. The data augmentation operations may generate additional versions or segments of a given training signal containing manipulated features mimicking a particular type of signal degradation or distortion. The analytics server 102 stores the training audio signals into the non-transitory medium of the analytics server 102 and/or the analytics database 106 for future reference or operations of the neural network architecture.

During the training phase and, in some implementations, the enrollment phase, fully connected layers of the neural network architecture generate a training feature vector for each of the many training audio signals and a loss function (e.g., LMCL) determines levels of error for the plurality of training feature vectors. A classification layer of the neural network architecture adjusts weighted values (e.g., hyper-parameters) of the neural network architecture until the outputted training feature vectors converge with predetermined expected feature vectors. When the training phase concludes, the analytics server 102 stores the weighted values and neural network architecture into the non-transitory storage media (e.g., memory, disk) of the analytics server 102. During the enrollment and/or the deployment phases, the analytics server 102 disables one or more layers of the neural network architecture (e.g., fully-connected layers, classification layer) to keep the weighted values fixed.

During the enrollment operational phase, an enrollee, such as an end-consumer of the provider system 110, provides several speech examples to the analytics system 101. For example, the enrollee could respond to various interactive voice response (IVR) prompts of IVR software executed by a provider server 111. The provider server 111 then forwards the recorded responses containing bona fide enrollment audio signals to the analytics server 102. The analytics server 102 applies the trained neural network architecture to each of the enrollee audio samples and generates corresponding enrollee feature vectors (sometimes called “enrollee embeddings”), though the analytics server 102 disables certain layers, such as layers employed for training the neural network architecture. The analytics server 102 generates an average or otherwise algorithmically combines the enrollee feature vectors and stores the enrollee feature vectors into the analytics database 106 or the provider database 112.

Layers of the neural network architecture are trained to operate as one or more embedding extractors that generate the feature vectors representing certain types of embeddings. The embedding extractors generate the enrollee embeddings during the enrollment phase, and generate inbound embeddings (sometimes called “test embeddings”) during the deployment phase. The embeddings include a spoof detection embedding (sometimes referred to as a “fakeprint” or “spoofprint”) and a speaker recognition embedding (sometimes referred to as a “voiceprint”). As an example, the neural network architecture generates an enrollee spoofprint and an enrollee voiceprint during the enrollment phase, and generates an inbound spoofprint and an inbound voiceprint during the deployment phase. Different embedding extractors of the neural network architecture generate the spoofprints and the voiceprints, though the same embedding extractor of the neural network architecture may be used to generate the spoofprints and the voiceprints in some embodiments.

As an example, the spoofprint embedding extractor may be a neural network architecture (e.g., ResNet, SyncNet) that processes a first set of features extracted from the input audio signals, where the spoofprint extractor comprises any number of convolutional layers, statistics layers, and fully-connected layers and trained according to the LMCL. The voiceprint embedding extractor may be another neural network architecture (e.g. (e.g., ResNet, SyncNet) that processes a second set of features extracted from the input audio signals, where the voiceprint embedding extractor comprises any number of convolutional layers, statistics layers, and fully-connected layers and trained according to a softmax function.

As a part of the loss function operations, the neural network performs a Linear Discriminant Analysis (LDA) algorithm or similar operation to transform the extracted embeddings to a lower-dimensional and more discriminative subspace. The LDA minimizes the intra-class variance and maximizes the inter-class variance between genuine training audio signals and spoof training audio signals. In some implementations, the neural network architecture may further include an embedding combination layer that performs various operations to algorithmically combine the spoofprint and the voiceprint into a combined embedding (e.g., enrollce combined embedding, inbound combined embedding). The embeddings, however, need not be combined in all embodiments. The loss function operations and LDA, as well as other aspects of the neural network architecture (e.g., scoring layers) are likewise configured to evaluate the combined embeddings, in addition or as an alternative to evaluating separate spoofprint and voiceprints embeddings.

The analytics server 102 executes certain data augmentation operations on the training audio signals and, in some implementations, on the enrollee audio signals. The analytics server 102 may perform different, or otherwise vary, the augmentation operations performed during the training phase and the enrollment phase. Additionally or alternatively, the analytics server 102 may perform different, or otherwise vary, the augmentation operations performed for training the spoofprint embedding extractor and the voiceprint embedding extractor. For example, the server may perform frequency masking (sometimes call frequency augmentation) on the training audio signals for the spoofprint embedding extractor during the training and/or enrollment phase. The server may perform noise augmentation for the voiceprint embedding extractor during the training and/or enrollment phase.

During the deployment phase, the analytics server 102 receives the inbound audio signal of the inbound phone call, as originated from the end-user device 114 of an inbound caller. The analytics server 102 applies the neural network on the inbound audio signal to extract the features from the inbound audio and determine whether the caller is an enrollee who is enrolled with the provider system 110 or the analytics system 101. The analytics server 102 applies each of the layers of the neural network, including any in-network augmentation layers, but disables the classification layer. The neural network generates the inbound embeddings (e.g., spoofprint, voiceprint, combined embedding) for the caller and then determines one or more similarity scores indicating the distances between these feature vectors and the corresponding enrollee feature vectors. If, for example, the similarity score for the spoofprints satisfies a predetermined spoofprint threshold, then the analytics server 102 determines that the inbound phone call is likely spoofed or otherwise fraudulent. As another example, if the similarity score for the voiceprints or the combined embeddings satisfies a corresponding predetermined threshold, then the analytics server 102 determines that the caller and the enrollee are likely the same person or that the inbound call is genuine or spoofed (e.g., synthetic speech).

Following the deployment phase, the analytics server 102 (or another device of the system 100) may execute any number of various downstream operations (e.g., speaker authentication, speaker diarization) that employ the determinations produced by the neural network at deployment time.

The analytics database 106 and/or the provider database 112 may contain any number of corpora of training audio signals that are accessible to the analytics server 102 via one or more networks. In some embodiments, the analytics server 102 employs supervised training to train the neural network, where the analytics database 106 includes labels associated with the training audio signals that indicate which signals contain speech portions. The analytics server 102 may also query an external database (not shown) to access a third-party corpus of training audio signals. An administrator may configure the analytics server 102 to select the speech segments to have durations that are random, random within configured limits, or predetermined at the admin device 105. The duration of the speech segments vary based upon the needs of the downstream operations and/or based upon the operational phase. For example, during training or enrollment, the analytics server 102 will likely have access to longer speech samples compared to the speech samples available during deployment. As another example, the analytics server 102 will likely have access to longer speech samples during telephony operations compared to speech samples received for voice authentication.

The provider server 111 of a provider system 110 executes software processes for managing a call queue and/or routing calls made to the provider system 110, which may include routing calls to the appropriate agent devices 116 based on the inbound caller's comments, instructions, IVR inputs, or other inputs submitted during the inbound call. The provider server 111 can capture, query, or generate various types of information about the call, the caller, and/or the end-user device 114 and forward the information to the agent device 116, where a graphical user interface (GUI) of the agent device 116 displays the information to the call center agent. The provider server 111 also transmits the information about the inbound call to the analytics system 101 to perform various analytics processes on the inbound audio signal and any other audio data. The provider server 111 may transmit the information and the audio data based upon a preconfigured triggering conditions (e.g., receiving the inbound phone call), instructions or queries received from another device of the system 100 (e.g., agent device 116, admin device 105, analytics server 102), or as part of a batch transmitted at a regular interval or predetermined time.

The provider server 111 executes software programming for an IVR program. The IVR program may provide for automated communications between the end-user (e.g., caller) on the end-user device 114 and the provider server 111 (or the agent on one of the agent devices 116). The IVR program may augment or facilitate call routing process from the caller in the end-user device 114 to the provider server 111. Upon the end-user device 114 initiating a call with the provider server 111, the IVR program on the provider server 111 may provide an audio prompt to the end-user device 114. The audio prompt may direct the caller to provide a request to the provider server 111. In response, the caller may provide a caller input via the end-user device 114 to the IVR program on the provider server 111. The caller input may be, for example, a caller voice input, keypad input, keyboard event, or a mouse event, among others. The IVR program may process the caller input (e.g., executing programming of an NLP algorithm) to extract information for additional process. The IVR program may provide an audio output to the caller to prompt for additional information. The IVR program may also forward or route the caller to one of the agent devices 116 at the provider server 111.

Non-limiting examples embodiments of machine-learning architectures extracting and analyzing such voiceprints and spoofprints (or “fakeprints”) may be found in U.S. Pat. No. 11,862,177, filed Jan. 22, 2021, and U.S. application Ser. No. 18/388,364, filed Nov. 9, 2023, each of which is incorporated by reference herein.

The admin device 105 of the analytics system 101 is a computing device allowing personnel of the analytics system 101 to perform various administrative tasks or user-prompted analytics operations. The admin device 105 may be any computing device comprising a processor and software, and capable of performing the various tasks and processes described herein. Non-limiting examples of the admin device 105 may include a server, personal computer, laptop computer, tablet computer, or the like. In operation, the user employs the admin device 105 to configure the operations of the various components of the analytics system 101 or provider system 110 and to issue queries and instructions to such components.

As mentioned, the provider system 110 forms the communications and business-logic core through which an end-user device 114 interacts with the organization. The end-user device 114 communicates with the provider system 110 via the channels 103 hosted and managed by the networks 104, including telephony channels and data channels. The end-user device may interact with the services of the provider system 110 to submit instructions or requests for the provider system 110 to perform various types of operations.

As an example, in some cases, the end-user interacts with an IVR system at the provider server 111 or live agent at the agent device 116, during a contact event (e.g., a phone call or chat-session) and submits requests for various types of operations, such as accessing or resetting credential or conducting a particular type of transaction, among others. As another example, in some cases, the end-user interacts with a web-app or chatbot hosted on the provider server 111, during a contact event (e.g., navigating a website with browser of the end-user device 114; accessing the web-based functions via a mobile application of the end-user device 114) and submits requests for various types of operations, such as accessing or resetting credential or conducting a particular type of transaction, among others.

The service provider system 110 includes the provider server 111 and agent device 116. The provider server 111 of the provider system 110 executes software processes for interacting with the end-users through the various channels. The processes may include, for example, routing calls to the appropriate agent devices 116 based on an inbound caller's comments, instructions, IVR inputs, or other inputs submitted during the inbound call. The provider server 111 can capture, query, or generate various types of information about the inbound audio signal, the caller, and/or the end-user device 114 and forward the information to the agent device 116. A graphical user interface (GUI) of the agent device 116 displays the information to an agent of the service provider. The provider server 111 also transmits the information about the inbound audio signal to the analytics system 101 to perform various analytics processes on the inbound audio signal and any other audio data. The provider server 111 may transmit the information and the contact data based upon preconfigured triggering conditions (e.g., receiving the inbound phone call), instructions or queries received from another device of the system 100 (e.g., agent device 116, admin device 105, analytics server 102), or as part of a batch transmitted at a regular interval or predetermined time. The agent device 116 of the provider system 110 may allow agents or other users of the provider system 110 to configure operations of devices of the provider system 110. For contact events directed to the provider system 110, the agent device 116 receives and displays some or all of the information associated with inbound end-user device information and inbound audio signals routed from the provider server 111.

The provider server 111 may receive a verification instruction or request to perform voice-based OTP authentication for an operation request initiated from the end-user device 114 during a contact event. The provider server 111 stores the contact event data, as received from the end-user device 114 and/or the agent device 116. In some cases, the verification request is initiated by the provider server 111, agent device 116, or analytics server 102 in response to determining that the requested operation is a type of secure operation that carries elevated risk, such as a password reset or high-value fund transfer. The provider server 111, agent device 116, or analytics server 102 may be preconfigured with a listing of the types of secure operations. The provider server 111 (or other device) assigns a unique request identifier, captures salient context (contact metadata, end-user identifier, operation information, and end-user device 114 information), and stores this information in the provider databases 112, analytics database 106, or an in-memory session record. The provider server 111 then transmits the operation request information from the various types of contact event data to the analytics server 102 and an instruction for the analytics server 102 to invoke the voice-based OTP authentication operations.

The analytics server 102 derives or receives the OTP text, prepares the OTP prompt having the OTP text, and transmits the OTP request to the end-user device 114. The analytics server 102 receives the OTP response from the end-user device 114, derives the various types of information from the OTP response (e.g., response text content; inbound voiceprint; inbound fakeprints) from an inbound audio signal, and computes one or more authentication scores (or similar types of scores) risk score. The analytics server 102 may return the authentication results, which may include the authentication scores and suggested authentication instruction, to the provider server 111 or agent device 116. The provider server 111 may, for example, relays the authentication results to end-user device 114 and/or the agent device 116. In some cases, the analytics server 102 handles the contact event based upon the authentication results, such that the analytics server 102 performs the functions of the operation or authorizes the provider server 111 to perform the operation of the operation request.

The analytics database 106 and/or the provider databases 112 may be hosted on any computing device (e.g., server, desktop computer) comprising hardware and software components capable of performing the various processes and tasks described herein, such as non-transitory machine-readable storage media and database management software (DBMS). The analytics database 106 and/or the provider databases 112 contains any number of corpora of training contact data (e.g., training audio signals, training metadata) that are accessible to the analytics server 102 via the one or more networks 104.

The analytics database 106 and/or the provider databases 112 may contain any number of corpora of training audio signals that are accessible to the analytics server 102 via one or more networks. In some embodiments, the analytics server 102 employs supervised training to train the neural network, where the analytics database 106 includes labels associated with the training audio signals that indicate which signals contain speech portions. The analytics server 102 may also query an external database (not shown) to access a third-party corpus of training audio signals. An administrator may configure the analytics server 102 to select the speech segments to have durations that are random, random within configured limits, or predetermined at the admin device 105. The duration of the speech segments vary based upon the needs of the downstream operations and/or based upon the operational phase. For example, during training or enrollment, the analytics server 102 will likely have access to longer speech samples compared to the speech samples available during deployment. As another example, the analytics server 102 will likely have access to longer speech samples during telephony operations compared to speech samples received for voice authentication.

The provider databases 112 or analytics database 106 may further store trained machine-learning models. For instance, after training a machine-learning model for speaker recognition or spoofing detection, the analytics server 102 stores the hyper-parameters, weights, or other terms of the particular machine-learning model into the analytics database 106, and may “fixes” the particular classifier and loss layers of the machine-learning model. The provider databases 112 or analytics database 106 may include data associated with the registered, enrolled users or enrolled end-user devices 114. The provider databases 112 or analytics database 106 may include data associated with the known fraudulent end-users or end-user devices 114. The provider databases 112 or analytics database 106 may include data associated with the contact events between the provider system 110 and end-user device 114.

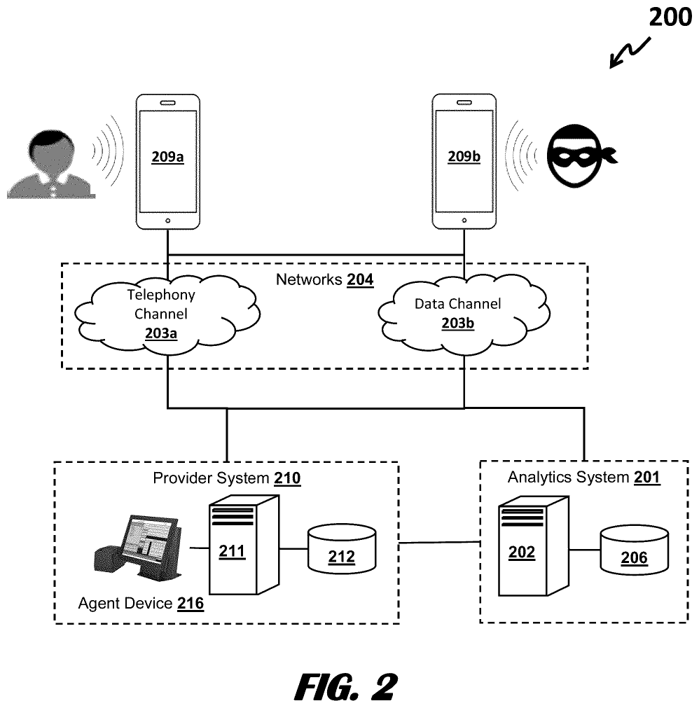

FIG. 2 shows components of a system 200 for analyzing content event data and authentication, according to an example embodiment. The system 200 comprises an analytics system 201, a provider system 210, end-user devices 209a-209b (generally referred to as end-user devices 209), and communications channels 203a-203b (generally referred to as communications channels 203), such as telephony channels 203a and data channels 203b, which may include public and private networks 204 (e.g., networks 104).

During a contact event in the example embodiment, the end-users operate the end-user devices 209 to place telephone calls to the provider system 210, which then captures and forwards various types of contact event data to the analytics system 201. For instance, when the provider system 210 receives an indication of an inbound telephone call, the provider server 211 stores and forwards various types of contact event data to an analytics server 202 of the analytics system 201. The analytics server 202 executes various software-based authentication processes to determine whether an inbound end-user device 209 is a registered device that is registered with (or otherwise trusted by) the provider system 210 or whether the inbound end-user device 209 is an imposter device that is unregistered with (or otherwise untrusted by) the provider system 210.

It should be appreciated that although FIG. 2 depicts one instance of each component, embodiments are not so limited and may include any number of the various components. In addition, embodiments may implement the various processes and tasks described herein through additional or fewer devices than what are described herein. For instance, other embodiments may incorporate an analytics database 206 into an analytics server 202 and still fall within the scope of this disclosure.

The system 200 includes any number of communication channels 203, such as the telephony channels 203a and the data channels 203b, which host and convey various types of communication exchanges between end-user devices 209 and the provider system 210 or analytics system 201. The telephony channel 203a may host device communications that are based on telephony protocols and comprises any number of devices capable of conducting and hosting telephonic communications. Non-limiting examples of components of the telephony channel 203a may include public exchanges (PBX), telephony switches, trunks, integrated services digital network (ISDN), public switch telephone network (PSTN), and the like. The data channel 203b may host device communications that are based on non-telephony, inter-device commutation protocols, such as TCP/IP, and comprises any number of devices capable of conducting and hosting networked communications. Non-limiting examples of components of the data channel 203b may include routers, network switches, proxy servers, firewalls, and the like.

The provider system 210 may receive inbound contact events (e.g., inbound calls, inbound data packets of an inbound instruction) from end-user devices 209 via the telephony channel 203a. For instance, inbound calls may be received at or routed to a computing device of the provider system 210, such as a provider server 211 (e.g., IVR server), an agent device 116, or other device of the provider system 210 capable of managing inbound calls. In some cases, devices of the provider system 210 may capture certain overhead metadata about the end-user devices 209 or the inbound call, where such metadata is received via the telephony channel 203a. In addition, the end-user may provide information about the end-user or the end-user devices 209, which the provider system 210 uses to, for example, route the inbound call or authenticate the call.

During a contact event, an end-user may operate an end-user device 209 to initiate the contact event with the provider system 210, which may include placing a telephone call to the provider system 210 through the telephony channel 203a or communicating with a live-chat session with an agent-user at an agent device 216 or chatbot executed at the provider server 211 via a data channel 203b, among other examples. In the example embodiment of the system 200, the provider server 211 receives call data via the telephony channel 203a and captures various metadata about the call and the end-user device 209. This metadata, along with any additional information provided by the end-user, such as authentication credentials or service requests, is forwarded to the analytics server 202 of the analytics system 201.

As an example, the end-user device 209 transmits an operation request to provider system 210 over the data channel 203b or the end-user speaks the operation request to an agent on a data channel 203b, which the agent enters as the operation request into the agent device 216. The operation request can represent any type or operation or action that the provider service may performing, including certain security-sensitive operations (e.g., resetting or unlocking a set of user credentials; authorizing a wire transfer that exceeds a configurable monetary threshold; activating a dormant account from a new geographic region). The request operation payload may include, for example, a device identifier, a user or account identifier, the requested operation code, and contextual attributes (e.g., domains, credentials, amounts), geolocation coordinates, or recent failed login count, among others. The provider server 211 may store this operation information into the provider database 212, analytics database 206, or a transient memory, in a session record keyed to one or more identifiers (e.g., operation identifier) and/or contact event.

The analytics server 202 processes the contact event data to generate an OTP, OTP prompt, and/or OTP request associated with the operation requestion received from the provider server 211. In generating the OTP, the analytics server 202 employs a variety of data inputs and algorithms. These inputs may include transaction context information, device data, and user credentials, among other types of data. For instance, the analytics server 202 may generate the OTP using a time of the transaction, a type of operation requested as indicated by the operation request, and a location of the end-user device 209, among others. Additionally or alternatively, the analytics server 202 may generate the OTP using one or more agent inputs entered at the agent device 216. The analytics server 202 generates text of the OTP intended for the end-user to read aloud, and then generates an OTP prompt that displays the text of the OTP at the user interface of the end-user device 209.

As an example, in some cases, the analytics server 202 generates the OTP having text selected or entered at the user interface of the agent device 216. Additionally or alternatively, in some cases, the analytics server 202 generates the text of the OTP using contextually relevant, operation information, such as the type of operation requested by the end-user, the name of a registered user associated with the operation, and a date and time of the operation request, among other types of information. The OTP prompt can be transmitted to the end-user device 209 and presented to the end-user in one or more formats, depending on the capabilities of the end-user device 209, such as text message, email, or push notification.

The end-user operates the end-user device 209 to initiate a transaction with the provider system 210. Once the provider system 210 captures and forwards the relevant contact event data to the analytics system 201, the analytics server 202 generates the OTP based on data inputs of the operation request, such as operation context information, device data, and user credentials, among the various other types of information. The analytics system 201 or the provider system 210 transmits the OTP prompt, containing the OTP text, to the end-user device 209.

The end-user device 209 then presents the OTP prompt to the end-user, who provides an OTP response. Upon receiving the OTP prompt, the end-user device 209 presents the text of the OTP to the end-user in a suitable format, such as a text message, email, or push notification. The end-user then reads aloud the OTP text, which is captured by a microphone of the end-user device 209 and used by the end-user device 209 to generate the OTP response. The end-user device 209 captures an inbound audio signal having the spoken audio signal and generates the OTP response. The end-user device 209 then transmits the end-user device 209 back to the analytics server 202 (or provider server 211) for authentication.

The analytics server 202 processes the OTP response to perform various operations that authenticate the end-user and the operations request. The analytics server 202 may verify the identity of the end-user using biometrics, such as a voiceprint, and authenticate the operation request based upon comparing expected text of the OTP request sent to the end-user device 209 against the response text of the OTP response returned from the end-user device 209. The analytics server 202 may execute various machine-learning models of a machine-learning architecture to determine a speaker recognition score using an inbound voiceprint and an enrolled voiceprint. The analytics server 202 may also execute one or more machine-learning models of the machine-learning architecture for performing NLP operations that generate text transcription of the spoken OTP response. The analytics server 202 may generate a content recognition score based upon comparing the expected text of the OTP request against received text transcribed using the audio signal of the OTP response from the end-user device 209.

In some implementations, the analytics server 202 may generate one or more inbound fakeprint embeddings (sometimes referred to as “fakeprints” or “spoofprints”) using features of the audio signal data or metadata received in the contact data. For instance, the analytics server 202 receives the inbound audio signal for the OTP response from the end-user device 209. The analytics server 202 applies the neural network on the inbound audio signal to extract the features from the inbound audio and determine whether the end-user is a registered enrolled user who is enrolled with the provider system 210 or the analytics system 201. The neural network generates the various inbound embeddings (e.g., one or more fakeprints, voiceprint) for the end-user and then determines one or more similarity scores indicating the distances between the inbound feature vector embeddings and the corresponding enrolled feature vector embeddings. If, for example, the liveness score or similarity score for the inbound fakeprint and the enrolled fakeprint satisfies a corresponding threshold score, then the analytics server 202 determines that the inbound end-user or inbound end-user device 209 is likely spoofed and the operation request is likely fraudulent.

The analytics server 202 may authenticate the operation request using the various scores generated for the inbound end-user device 209, such as the speaker recognition score, the OTP response content score, and, optionally, one or more liveness scores (sometimes referred to as fraud scores or spoofing scores). In some cases, the analytics server 202 may transmit the authentication results to the provider server 211 and/or the agent device 216, which then present the authentication results to a user interface of the agent device 216 and prompt the agent device on whether to permit or deny the operation request. In some cases, the analytics server 202 may transmit the authentication results to the provider server 211 or the agent device 216 with an instruction to perform or reject or halt the operation indicated by the operation request.

In some implementations, the provider server 211 or analytics server 202 receives a device identifier of the end-user device 209 associated with the operation request in the contact event, and queries a provider database 212 or analytics database 206 for a contact identifier (e.g., email, device identifier, mobile application identifier, phone number) for transmitting information or otherwise contacting the end-user device 209. The provider server 211 or analytics server 202 transmits the OTP request to the 209 using the contact identifier. In this way, a registered device 209a may communicate with the provider system 210 and would receive the OTP request from the analytics server 202 or provider server 211, while an imposter device 209b would not receive or might be unable to receive the OTP request because the OTP request is sent to another destination (e.g., the registered device 209a) and/or the imposter device 209b may not be properly configured.

The provider server 211 transmits the contact event data to the analytics server 202 of the analytics system 201 with a verification request (e.g., authentication request, anti-fraud request). The verification request contains executable instructions for the analytics server 202 to perform the various authentication operations and may include various types of contact event data, such as device data related to the end-user device 209 or end-user, and operation information related to the operation request initiated at the end-user device 209.

In some implementations, the provider server 211 or analytics server 202 executes a pre-screening workflow in which the provider server 211 or analytics server 202 determines whether to invoke the full voice-based OTP operations. When a contact event arrives, the provider server 211 or analytics server 202 compares the operation or operation code indicated by the operation request against a preconfigured or stored list of secure operations to determine whether the user-requested operation is a type of secure operation on the listing. In some cases, the provider server 211 or analytics server 202 executes an initial scoring engine that computes an initial operation request risk score based upon the data received in the contact event data, such as caller ANI, account history, requested operation type, recent authentication outcomes, and device reputation score, among others. In some cases, the provider server 211 may execute a scoring engine that classifies the operation request on the basis of, for example, an operation code indicating the operation or type of operation, dollar magnitude, channel velocity, or user-defined policy, among other types of contact event data. In such cases, the provider server 211 or analytics server 202 invokes the voice-based OTP operation in response to determining that the initial risk score satisfies an initial operation request risk threshold or in response to determining that the operation is indicated in the list of secured operations. In this way, the provider server 211 or analytics server 202 may implement a selective approach and/or a stepped-up approach for deploying the voice-based OTP operation on certain operations or in certain circumstances.

The analytics server 202 of the analytics system 201 receives the contact event data and generates an OTP using various types of data of the contact event data, such as the transaction context information, among other types of data. The analytics server 202 then generates an OTP prompt for presentation (e.g., visually, aurally) at the end-user device 209 to the end-user, via a graphical user interface or audio speaker of the end-user device 209.

The analytics server 202 references various types of event data as a unique collection of information within the context of the end-user's requested transaction in order to generate the OTP, which the analytics server 202 generates and temporarily stores (as an expected input) for authenticating the end-user devices 209 before executing the requested transaction.

In some implementations, the OTP prompts are automatically generated by the analytics server 202 (or other device of the system 200) and transmitted to the end-user device 209 that submitted or initiated the operation request to the provider system 210 or agent device 216. Based on the operation information or other contact event data received from the provider server 211, the analytics server 202 generates a unique OTP text. This OTP text is context-specific and may include certain operation information relative to the requested operation, such as a description of the requested operation, and date and time, among other possible operation information, such as a transaction amount, end-user name, recipient name, or purpose (e.g., “I authorize a wire transfer of $25,000 to Drexel University”).

In some implementations, the analytics server 202 executes generative machine-learning model, such as a Large-Language Model (LLM), trained to automatically generate the OTP text and OTP prompts. The LLM may be trained and programmed to generate the OTP text by understanding the operation information for the operation request from the end-user device 209. The LLM may analyze the input operation information and contact event data using natural language processing techniques to extract relevant operation information. The LLM would then generate a coherent and context-specific OTP text that reflects the operation information details. For example, if the operation request is for a wire transfer, the LLM may generate an OTP text of: “I authorize a wire transfer of $25,000 to Drexel University.”

Additionally or alternatively, in some implementations, the analytics server 202 or other device of the system 200 generates the OTP according to stored, preconfigured instructions and/or user inputs received from an agent device 216, which may be entered by an agent-user at the agent device 216 during the contact event. For instance, the agent may operate a user interface of the agent device 216 to select or enter certain context information that the analytics server 202 (or agent device 216) references to generate the OTP, which the analytics server 202 (or agent device 216) then uses to generate the OTP prompt. In this way, the agent may operate the agent device 216 to select the information for generating the OTP to be sent in the OTP prompt to the end-user device 209.

The analytics system 201 then transmits the OTP prompt to the end-user device 209 via one or more communication channels 203, which may be the same or different communications channel 203 through which the provider system 210 received the inbound contact event. As an example, the provider system 210 may receive an inbound call via a telephony channel 203a from a registered device 209a and the analytics system 201 or provider system 210 may return or otherwise transmit the OTP prompt via the data channel 203b for visual display at the registered device 209a. The analytics server 202 (or other device of the analytics system 201) uses certain information received in the end-user's OTP response in order to perform various processes, such as authentication or registration.

The OTP prompt may request various types of verifying information from the end-user and the end-user device 209, including an audio signal containing the spoken OTP response and, optionally, various types of metadata associated with the end-user device 209 or end-user, among other types of verifying information. Non-limiting examples may include a request for one or more attributes of the end-user device 209 or other predetermined types of data, and a request that includes a message notification for the end-user to speak the OTP displayed at the user interface of the end-user device 209.

The provider system 210 or analytics system 201 generates and transmits the OTP prompt in one or more formats. Non-limiting examples of the OTP prompt may include text messages (e.g., SMS, MMS), emails, and push notifications, among others. The analytics system 201 transmits the OTP prompt to the end-user device 209 via the type of communications channel 203 corresponding to the type of data format of the OTP prompt.

As an example, in some cases, the analytics system 201 transmits the OTP prompt as a push notification, via a corresponding data channel 203b, for a mobile application associated with the provider system 210 and installed on the end-user device 209. In such cases, the end-user device 209 may install and execute the mobile application that enables the end-user device 209 to receive the OTP prompt as the push notification via the data channel 203b having hardware and software components. Because an imposter device 209b will not have the mobile application installed, the imposter device 209b would be inhibited from receiving the OTP prompt.

Upon receiving the OTP request, the end-user device 209 displays the OTP prompt at the user interface of the end-user device 209. The OTP prompt may include OTP text of the OTP that the end-user is required to speak. The OTP text may reflect information about the operation request that the analytics server 202 used to generate the OTP, such as the end-user name who initiates the operation, service provider sending the request, the reason for verification, and other context-specific details related to the operation being performed. Additionally or alternatively, the OTP prompt may display the same or similar operation information to the end-user. The end-user interacts with the user interface to provide inputs that answer the OTP request, including speaking the text of the OTP into a microphone of the end-user device 209.

The end-user device 209 captures the speech audio of the user speaking the OTP. This audio signal is then forwarded to the analytics server 202 as part of the OTP response. The response may also include additional required information, such as user metadata or answers to verification questions. The analytics server 202 receives the OTP response and uses the provided information to perform various processes, such as authenticating the end-user device and verifying the transaction details.

The analytics server 202 receives an OTP response from the end-user device 209, and authenticates the operation request and end-user device 209 based upon the OTP response. The analytics server 202 may, for example, generate a voice-based speaker recognition score, an OTP content recognition score, and one or more liveness (or spoofing or fraud risk scores).

During the authentication process, the user reads the OTP text aloud, and the voice is captured using the microphone on end-user device 209. The analytics server 202 extracts biometric acoustic features from the inbound voice audio signal sample provided in the OTP response. These acoustic features include, for example, an inbound voiceprint of spectral and temporal characteristics that are generally unique to the end-user's voice. The analytics server 202 compares the inbound voiceprint against an enrolled voiceprint stored in the analytics database 206 or provider database 212. The analytics server 202 may determine a distance between the inbound voiceprint and the enrolled voiceprint, indicating a similarity score or voice recognition score that represents the likelihood that the end-user speaker is a registered enrolled user associated with the enrolled voiceprint. The analytics server 202 may compare the voice recognition score against a predefined threshold. If the score meets or exceeds the threshold, the voice biometric verification is considered successful, confirming that the voice of the end-user belongs to the enrolled user.

During the authentication process, the analytics server 202 generates an OTP content recognition score. The server receives the inbound audio recording of the end-user's spoken response to the OTP text. The analytics server 202 applies an ASR engine or similar NLP engine to convert the inbound speaker audio recording into the inbound response text, in which the analytics server 202 analyzes the inbound audio signal to identify phonemes and words, to produce the textual representation of the spoken response of the OTP response. The analytics server 202 compares the ASR-generated, inbound text against the original OTP text. The analytics server 202 may perform this text-to-text comparison using various techniques such as determining a Levenshtein distance or an edit distance to measure a similarity between the two texts. The analytics server 202 calculates the content recognition score based on the similarity between the ASR-generated, inbound text and the original OTP text. The analytics server 202 determines whether the end-user spoke the correct OTP by evaluating the content recognition score against a predefined threshold. If the score meets or exceeds the threshold, then the analytics server 202 determines that response is correct and the end-user spoke the correct OTP.

During the authentication process, the user reads the OTP text aloud, and the voice is captured using the microphone on end-user device 209. The analytics server 202 extracts various types of acoustic features from the inbound audio signal provided in the OTP response and/or various types of metadata obtained in the communications with the end-user device 209 via the communications channels 203. The analytics server 202 may then extract various types acoustic features or metadata features to generate one or more inbound fakeprints. The analytics server 202 compares the inbound fakeprints against enrolled fakeprints stored in the analytics database 206 or provider database 212. The analytics server 202 may determine a distance between the inbound fakeprints and the corresponding enrolled fakeprints, indicating a similarity score or liveness score that represents the likelihood that inbound audio signal or inbound metadata contains a type of fraud and thus indicates the likelihood that the end-user is fraudulent or the end-user device 209 is fraudulent. The analytics server 202 may compare the one or more liveness scores against one or more corresponding predefined thresholds. If the score satisfies the threshold, then the analytics server 202 determines that the OTP response likely contains fraud, and the operation request should be rejected as fraudulent.

After generating the various scores, the analytics server 202 proceeds with the authentication and verification processes based on the obtained authentication results. The analytics server 202 evaluates the voice-based speaker recognition score. If the similarity score between the inbound and enrolled voiceprints meets or exceeds the predefined threshold, the analytics server 202 authenticates the voice biometric verification as successful. This means the end-user's identity is authenticated, and the operation request can be processed further. The analytics server 202 evaluates the OTP content recognition score by comparing the ASR-generated text of the spoken OTP response to the original OTP text, the analytics server 202 calculates the content recognition score. If this score exceeds the set threshold, the analytics server 202 verifies that the end-user has correctly spoken the OTP, which further authenticates the operation request. In cases where the content recognition score is lower than the threshold, the analytics server 202 may request the end-user to repeat the OTP or provide additional verification information. The analytics server 202 evaluates the various liveness scores to detect potential fraudulent activity by comparing inbound fakeprints against stored fakeprints. If the liveness scores suggest a high likelihood of fraud, the analytics server 202 rejects the operation request to prevent unauthorized access or transactions.

The analytics server 202 may generate and output authentication results based upon the various scores. In some cases, the analytics server 202 transmits the authentication scores for display at the user interface of the agent device 216. The analytics server 202 may further generate an authentication score or other output based upon comparing each of the scores against corresponding threshold values. Optionally, the analytics server 202 may automatically authenticate the inbound contact event in which the analytics server 202 may determines whether to permit or reject the operation request based upon the authentication results, authentication scores, and the corresponding threshold values.

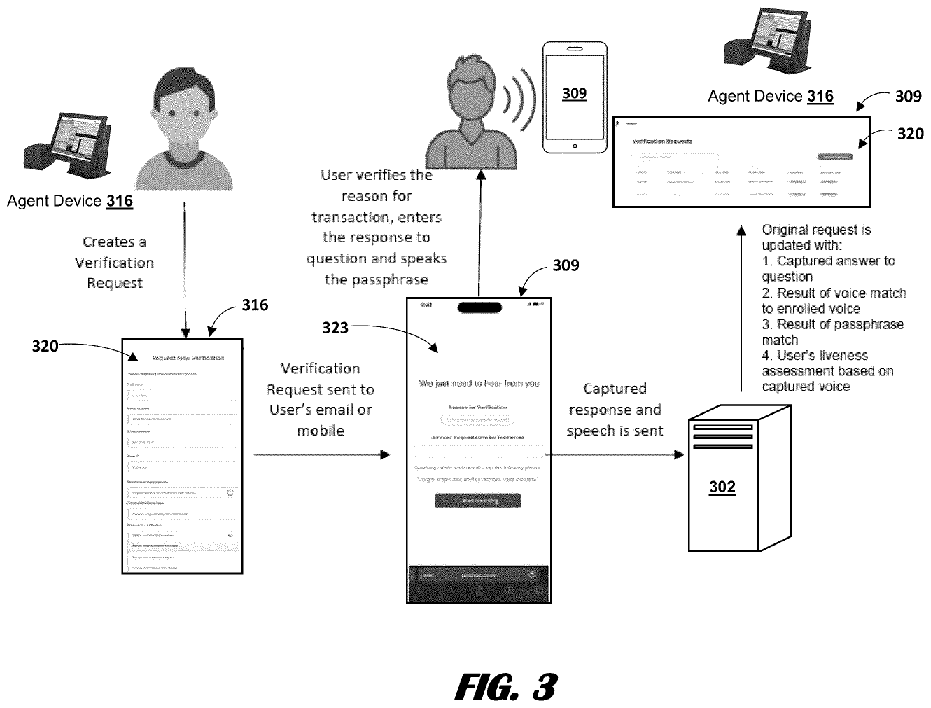

FIG. 3 shows dataflow amongst components of an example system 300 for authenticating end-user using voice-based OTPs, according to embodiments. The system 300 includes an analytics server 302, an end-user device 309, and agent device 316, similar to those previously described herein.

During a contact event, an end-user contacts a provider system and communicates with an agent (e.g., telephony-based call, online chat session) or interacts with an automated program (e.g., IVR, chatbot). The user requests an operation that involves a particular type of operation that invokes an OTP-based authentication operation. The agent user may enter operation information at a user interface 320 of the agent device 316 to generate the operation request, or a computing program executed by the agent device 316 or provider server may automatically generate the operation request.

For instance, the agent of the provider system receives the user's request, enters operation information into the user interface 320, and initiates an OTP-based operation request for the analytics server 302. This operation request may include, for example, a user identifier, user contact information (e.g., trusted email or mobile number), and the OTP generated by the analytics server 302 or selected at the agent user interface 320, among other types of information (e.g., reason for OTP-based verification; a question requiring end-user input around the context of the requested). The analytics server 302 may store the operation request into a database (e.g., analytics server 102 provider databases 112) with the related transaction information and associated with the end-user identifier or contact information.

The analytics server 302 transmits an OTP request to an end-user device 309. The OTP request includes an OTP prompt for displaying the text of the OTP at an end-user interface 323 of the end-user device 309. This OTP request is sent as a link to the user contact information (e.g., the mobile number or email address) provided in the operation request and stored in the database.

Upon receiving the OTP request at the end-user device 309, the end-user clicks on the link displayed in the end-user interface 323 to access the OTP prompt. The OTP prompt may display, for example, text of the OTP for the end-user to speak; a service provider organization sending the OTP request; the reason for verification; a question requiring user input around the context of the transaction being performed, and other types of information. The end-user enters or otherwise provides inputs that answer to the OTP request, including a spoken response to the OTP presented at the end-user interface 323. The end-user enters answers to the question(s) and speaks the text of the OTP and the software of the end-user device 309 captures the speech audio of the user speaking the OTP, which the end-user device 309 forwards to the analytics server 302 as an inbound audio signal having the inbound speech audio in the OTP response.

The analytics server 302 receives the OTP response, from the end-user device 309 or the agent device 316. The OTP response includes a user identifier and an operation request identifier, which the analytics server 302 uses to query the database for the particular transaction request and the various types of information received in the OTP response, such as the recording of the inbound audio signal having the inbound speaker signal and other types of information received in the OTP response from the end-user device 309.

The analytics server 302 generates a speaker recognition score for the operation request. The analytics server 302 includes an embedding extractor machine-learning model (e.g., neural network model) that extracts the inbound voiceprint using acoustic features extracted from the inbound speaker signal. Using the user identifier obtained in the OTP response or at another moment from the end-user device 309 during the contact event, the analytics server 302 may retrieve an enrolled voiceprint stored in the database associated with an enrolled user data record having the user identifier. The analytics server 302 then executes a machine-learning model that generates a speaker recognition score based upon the distance between the inbound voiceprint and the enrolled voiceprint.

The analytics server 302 generates an OTP content recognition score for the operation request. The analytics server 302 executes a machine-learning model, such as an ASR engine, that generates a text transcription of the inbound speaker signal in the OTP response. The analytics server 302 then compares the generated text of the OTP response against the stored, expected text of the OTP request. In some cases, the analytics server 302 may determine a binary output as the content recognition score based upon comparing the text strings. In some cases, the analytics server 302 may determine the content recognition score using a machine-learning model that determines a distance or score indicating a level of discrepancy between the text strings.

The analytics server 302 generates one or more liveness scores for the operation request, indicating a likelihood of spoofing or fraud. As an example, the analytics server 302 executes one or more embedding extractors as machine-learning models (e.g., neural network models) that extract one or more inbound fakeprints (or “spoofprints”) using the acoustic features extracted from the inbound speaker signal and/or from the broader inbound audio signal. Using the user identifier obtained in the OTP response or at another moment from the end-user device 309 during the contact event, the analytics server 302 may retrieve one or more stored or otherwise enrolled fakeprints stored in the database. The analytics server 302 then executes a machine-learning model that generates a liveness score based upon the distance between the inbound fakeprint and the enrolled fakeprints.

The analytics server 302 may generate and output an authentication result based upon the various scores. In some cases, the analytics server 302 transmits the authentication scores for display at the user interface 320 of the agent device 316. The analytics server 302 may further generate an authentication score or other output based upon comparing each of the scores against corresponding threshold values. Optionally, the analytics server 302 may automatically authenticate the inbound contact event in which the analytics server 302 may determine whether to permit or reject the operation request based upon the authentication results, authentication scores, and the corresponding threshold values.

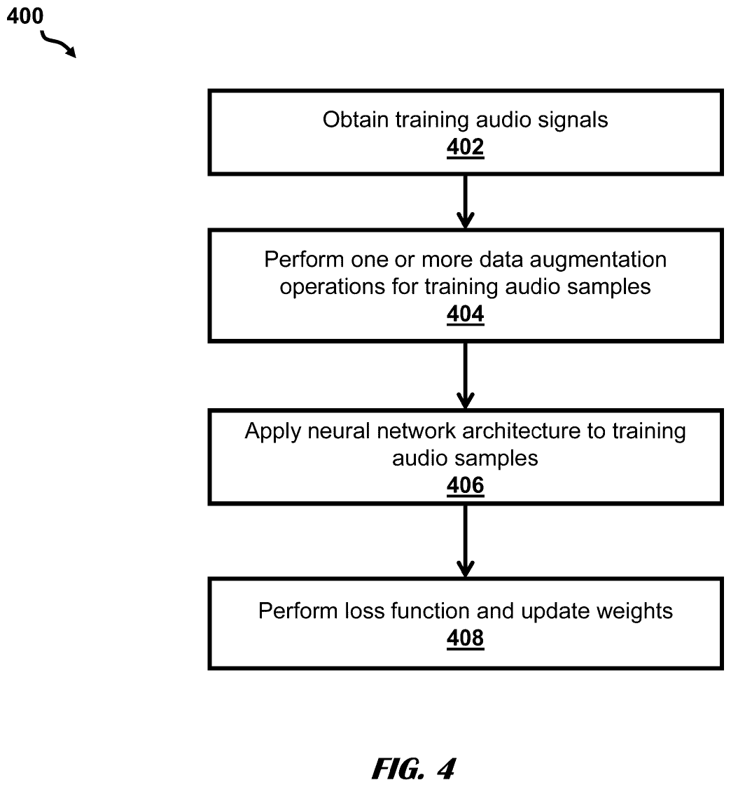

FIG. 4 shows operations of a method 400 for training operations of one or more machine-learning architectures, such as neural networks architectures, for spoof detection and speaker recognition, according to an embodiment. Embodiments may include additional, fewer, or different operations than those described in the method 400. The method 400 is performed by a server executing machine-readable software code of the neural network architectures, though it should be appreciated that the various operations may be performed by one or more computing devices and/or processors.

The server or layers of the neural network architecture may perform various pre-processing operations on an input audio signal (e.g., training audio signal, enrollment audio signal, inbound audio signal). These pre-processing operations may include, for example, extracting low-level features from the audio signals and transforming these features from a time-domain representation into a frequency-domain representation by performing Short-time Fourier Transforms (SFT) and/or Fast Fourier Transforms (FFT). The pre-processing operations may also include parsing the audio signals into frames or sub-frames, and performing various normalization or scaling operations. Optionally, the server performs any number of pre-processing operations before feeding the audio data into the neural network. The server may perform the various pre-processing operations in one or more of the operational phases, though the particular pre-processing operations performed may vary across the operational phases. The server may perform the various pre-processing operations separately from the neural network architecture or as in-network layer of the neural network architecture.

The server or layers of the neural network architecture may perform various augmentation operations on the input audio signal (e.g., training audio signal, enrollment audio signal). The augmentation operations generate various types of distortion or degradation for the input audio signal, such that the resulting audio signals are ingested by, for example, the convolutional operations that generate the feature vectors. The server may perform the various augmentation operations as separate operations from the neural network architecture or as in-network augmentation layers. The server may perform the various augmentation operations in one or more of the operational phases, though the particular augmentation operations performed may vary across the operational phases.

During a training phase, the server applies a neural network architecture to training audio signals (e.g., clean audio signals, simulated audio signals, previously received observed audio signals). In some instances, before applying the neural network architecture to the training audio signals, the server pre-processes the training audio signals according to various pre-processing operations described herein, such that the neural network architecture receives arrays representing portions of the training audio signals.

In operation 402, the server obtains the training audio signals, including clean audio signals and noise samples. The server may receive or request clean audio signals from one or more speech corpora databases. The clean audio signals may include speech originating from any number speakers, where the quality allows the server to identify the speech—e.g., the clean audio signal contains little or no degradation (e.g., additive noise, multiplicative noise). The clean audio signals may be stored in non-transitory storage media accessible to the server or received via a network or other data source. In some circumstances, the server generates a simulated clean audio signal using simulated audio signals. For example, the server may generate a simulated clean audio signal by simulating speech.

In operation 404, the server performs one or more data augmentation operations using the clean training audio samples and/or to generate simulated audio samples. For instance, the server generates one or more simulated audio signals by applying augmentation operations for degrading the clean audio signals. The server may, for example, generate simulated audio signals by applying additive noise and/or multiplicative noise on the clean audio signals and labeling these simulated audio signals. The additive noise may be generated as simulated white Gaussian noise or other simulated noises with different spectral shapes, and/or example sources of backgrounds noise (e.g., real babble noise, real white noise, and other ambient noise) on the clean audio signals. The multiplicative noise may be simulated acoustic impulse responses. The server may perform additional or alternative augmentation operations on the clean audio signals to produce simulated audio signals, thereby generating a larger set of training audio signals.

In operation 406, the server uses the training audio signals to train one or more neural network architectures. As discussed herein, the result of training the neural network architecture is to minimize the amount of error between a predicted output (e.g., neural network architecture outputted of genuine or spoofed; extracted features; extracted feature vector) and an expected output (e.g., label associated with the training audio signal indicating whether the particular training signal is genuine or spoofed; label indicating expected features or feature vector of the particular training signal). The server feeds each training audio signal to the neural network architecture, which the neural network architecture uses to generate the predicted output by applying the current state of the neural network architecture to the training audio signal.

In operation 408, the server performs a loss function (e.g., LMCL, LDA) and updates hyper-parameters (or other types of weight values) of the neural network architecture. The server determines the error between the predicted output and the expected output by comparing the similarity or difference between the predicted output and expected output. The server adjusts the algorithmic weights in the neural network architecture until the error between the predicted output and expected output is small enough such that the error is within a predetermined threshold margin of error and stores the trained neural network architecture into memory.

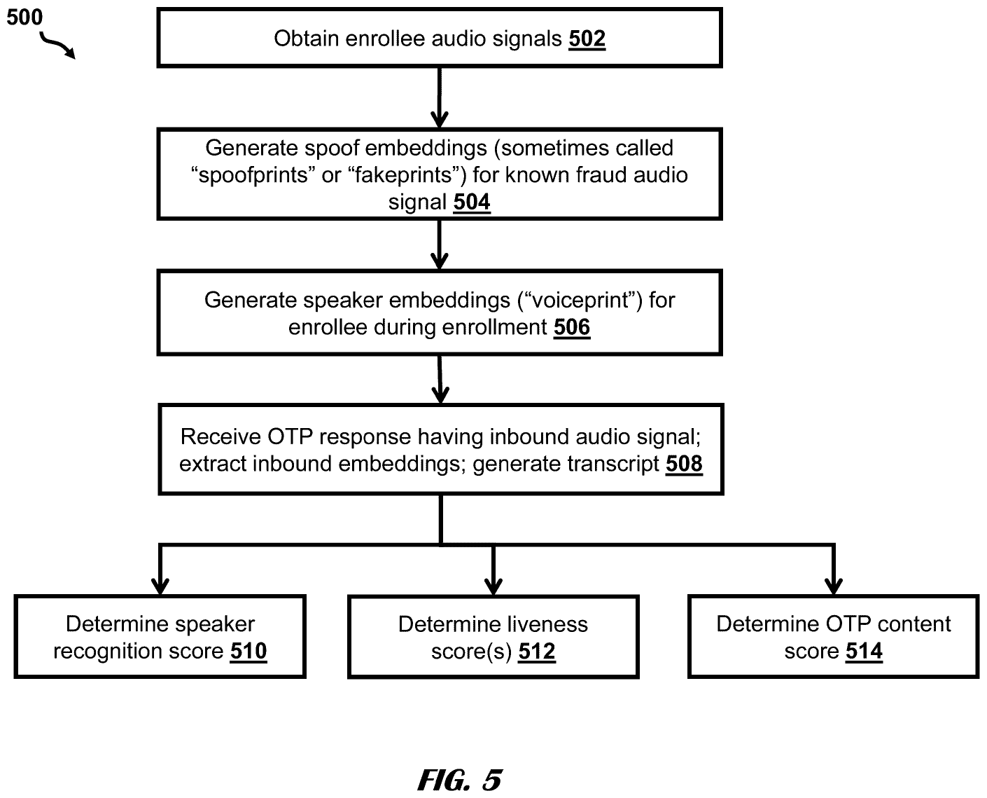

FIG. 5 shows steps of a method 500 for enrollment and deployment operations of one or more neural networks architectures for spoof detection and speaker recognition, according to an embodiment. Embodiments may include additional, fewer, or different operations than those described in the method 500. The method 500 is performed by a server executing machine-readable software code of the neural network architectures, though it should be appreciated that the various operations may be performed by one or more computing devices and/or processors.

During an enrollment phase, the server applies a neural network architecture to bona fide enrollee audio signals. In some instances, before applying the neural network architecture to the enrollee audio signals, the server pre-processes the enrollee audio signals according to various pre-processing operations described herein, such that the neural network architecture receives arrays representing portions of the enrollee audio signals. In operation, embedding extractor layers of the neural network architecture generate feature vectors based on features of the enrollee audio signals and extract enrollee embeddings, which the server later references during a deployment phase. In some embodiments, the same embedding extractor of the neural network architecture is applied for each type of embedding, and in some embodiments different embedding extractors of the neural network architecture are applied for corresponding types of embeddings.

In operation 502, the server obtains the enrollee audio signals for the various types of fraud that may be employed in enrollment audio signals. The server may receive the enrollment audio signals directly from a device (e.g., telephone, IoT device), a database, or a device of a third-party (e.g., provider system). In some implementations, the server may perform one or more data augmentation operations on the enrollment audio signals, which could include the same or different augmentation operations performed during a training phase. In some cases, the server extracts certain features from the enrollment audio signals. The server extracts the features based on the relevant types of enrollment embeddings. For instance, the types of features used to produce a spoofprint can be acoustic features used to produce fraudulent acoustic features in an enrollment audio signal that is known to contain fraud. In some cases, the types of features used to produce a spoofprint can be different from the types of features used to produce a voiceprint.

In operation 504, the server applies the neural network architecture to each enrollment audio signal to extract the enrolled spoofprint for types of fraudulent audio signals. The neural network architecture generates spoofprint feature vectors for the enrollment audio signals using the relevant set of extracted spoofing enrollment features. The neural network architecture extracts the spoofprint embedding by combining the spoofprint feature vectors according to various statistical and/or convolutional operations. The server then stores the enrolled spoofprint embedding into non-transitory storage media, such as a database (e.g., analytics database 106).

In operation 506, the server applies the neural network architecture to each enrollee audio signal to extract the enrollee voiceprint. The neural network architecture generates voiceprint feature vectors for the enrollee audio signals using the relevant set of extracted features, which may be the same or different types of features used to extract the spoofprint. The neural network architecture extracts the voiceprint embedding for the enrollee by combining the voiceprint feature vectors according to various statistical and/or convolutional operations. The server then stores the enrollee voiceprint embedding into non-transitory storage media.

At deployment time, in step 508, the server receives an OTP response containing an inbound audio signal having an inbound speaker audio signal and extracts various inbound embeddings, including an inbound voiceprint for the speaker and one or more inbound spoofprint embeddings using the inbound audio signal. The server applies the neural network architecture to the inbound audio signal of the OTP response to extract, for example, an inbound spoofprint and an inbound voiceprint.

The server may also extract transcribed text content from the speaker audio signal received in the OTP response. The server may perform data acquisition of the text from audio transcription algorithms to convert the audio to text-based transcription to determine whether the end-user spoke the expected OTP generated for the operation request. The server may pre-process the text data by conducting text cleaning such as removing stop words, stemming the words, and converting the text to lower case, among others.

In some cases, the server may apply an automated speech recognition (ASR) algorithm to the inbound speaker audio signal of the OTP response to extract the text content for the end-user's OTP response.

In some cases, the server may apply at least one feature extractor of the machine-learning architecture to the textual content output, determine, or otherwise generate a set of natural language processing (NLP) features. The feature extractor may include a ML model, AI algorithm, or other algorithm of the machine-learning architecture to generate features from the text converted from the audio. The feature extractor may be maintained on the computer, or a separate service invoked by the computer. The NLP features may be used to determine whether speaker in the audio speech signal recited the correct OTP text in the OTP prompt. In general, the server may input or feed the textual content generated from the audio speech signal to the feature extractor. The server may process the input textual content in accordance with the feature extractor. For example, the computer may process the input textual content using the set of weights of the ML model of the feature extractor of the machine-learning architecture. From processing using the feature extractor, the server may generate one or more NLP features. The NLP features may include any one or more of those described herein.

In operation 510, the server determines a speaker recognition score as a similarity score for the OTP response. The speaker recognition score is based upon a distance between the inbound voiceprint and the enrolled voiceprint of the end-user. The server then determines whether the similarity score satisfies a speaker recognition threshold.

In operation 512, the server determines a liveness score and/or one or more spoof or fraud detection scores for the OTP response. For instance, the liveness score may a similarity score based upon the distance between the inbound spoofprint and the enrolled spoofprint. The server then determines whether the liveness satisfies a corresponding threshold score (sometimes a referred to as a liveness score threshold, fraud risk score threshold).

In operation 514, the server determines the OTP content score that indicates an amount of similarity between the inbound text of the inbound OTP content spoken by the end-user as compared against the expected text of the OTP generated for the operation request. As mentioned, additional examples for generating the text transcript of an end-user's speech signal and evaluating the text transcript may be found in U.S. application Ser. No. 18/388,364.

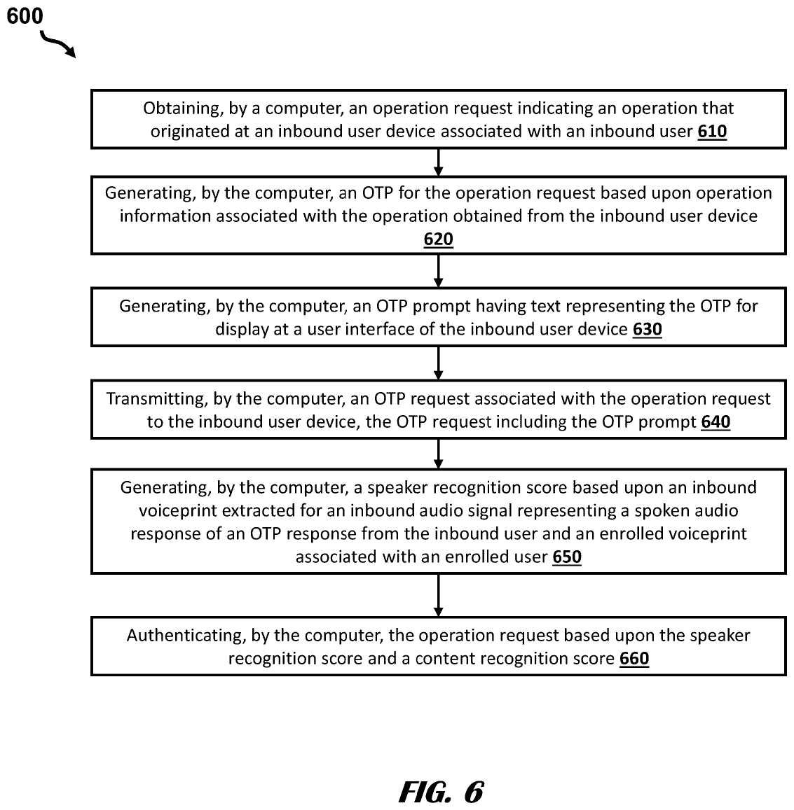

FIG. 6 shows operations of a computer-executed method 600 for authentication using OTPs, according to embodiments. Embodiments may include additional, fewer, or different operations than those described in the method 600. The method 600 is performed by a computer (e.g., analytics server 102, 202, 302) executing machine-readable software code of a neural network architecture comprising any number of neural network layers and neural networks, though the various operations may be performed by one or more computing devices and/or processors.

At operation 610, the computer obtains an operation request indicating an operation that originated at an inbound user device associated with an inbound user. At operation 620, the computer generates an OTP for the operation request based upon operation information associated with the operation obtained from the inbound user device.

At operation 630, the computer generates an OTP prompt having text representing the OTP for display at a user interface of the inbound user device. At operation 640, the computer transmits an OTP request associated with the operation request to the inbound user device, the OTP request including the OTP prompt.

At operation 650, the computer generates a speaker recognition score based upon an inbound voiceprint extracted for an inbound audio signal representing a spoken audio response of an OTP response from the inbound user and an enrolled voiceprint associated with an enrolled user. At operation 660, the computer authenticates the operation request based upon the speaker recognition score and a content recognition score.

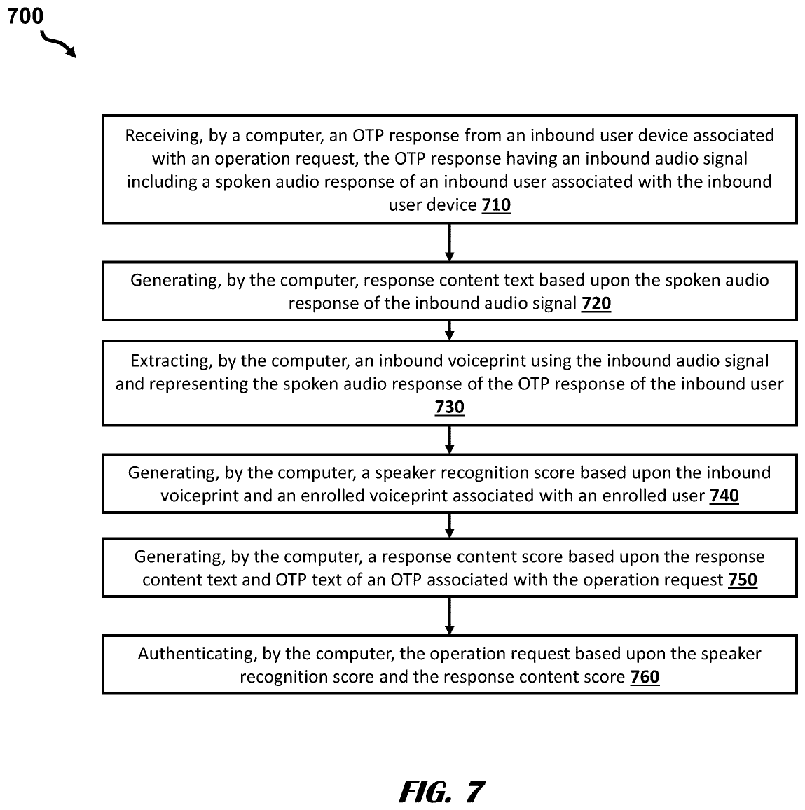

FIG. 7 shows operations of a computer-executed method 700 for authentication using OTPs, according to embodiments. Embodiments may include additional, fewer, or different operations than those described in the method 700. The method 700 is performed by a computer (e.g., analytics server 102, 202, 302) executing machine-readable software code of a neural network architecture comprising any number of neural network layers and neural networks, though the various operations may be performed by one or more computing devices and/or processors.

At operation 710, the computer receives an OTP response from an inbound user device associated with an operation request, the OTP response having an inbound audio signal including a spoken audio response of an inbound user associated with the inbound user device.

At operation 720, the computer generates response content text based upon the spoken audio response of the inbound audio signal. At operation 730, the computer extracts an inbound voiceprint using the inbound audio signal and representing the spoken audio response of the OTP response of the inbound user.

At operation 740, the computer generates a speaker recognition score based upon the inbound voiceprint and an enrolled voiceprint associated with an enrolled user. At operation 750, the computer generates a response content score based upon the response content text and OTP text of an OTP associated with the operation request. At operation 760, the computer authenticates the operation request based upon the speaker recognition score and the response content score.

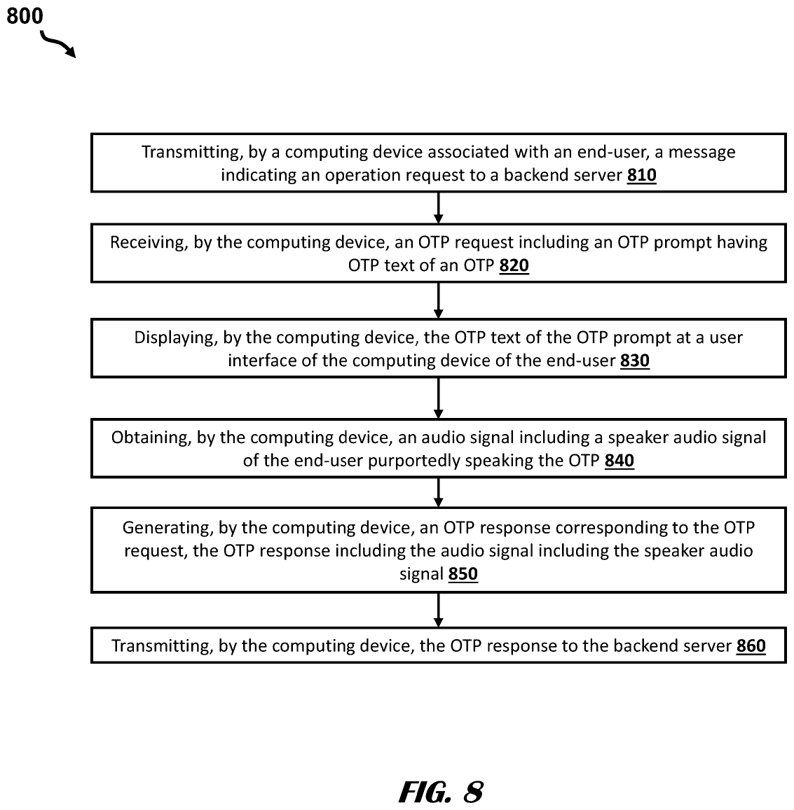

FIG. 8 shows operations of computer-implemented method 800 for authentication using a voice-based one-time password (OTP) at an end-user device, according to embodiments. Embodiments may include additional, fewer, or different operations than those described in the method 800. The method 800 is performed by a computing-device (e.g., end-user device 114, end-user device 209, end-user device 309) executing machine-readable software code of a neural network architecture comprising any number of neural network layers and neural networks, though the various operations may be performed by one or more computing devices and/or processors

At operation 810, a computing device associated with an end-user transmits a message indicating an operation request to a backend server (e.g., analytics server 102, provider system 110). At operation 820, the computing device receives an OTP request that includes an OTP prompt having OTP text of an OTP. At operation 830, the computing device displays the OTP text of the OTP prompt at a user interface of the computing device of the end-user.

At operation 840, the computing device obtains an audio signal including a speaker audio signal of the end-user purportedly speaking the OTP text displayed at the user interface in the OTP prompt. At operation 850, the computing device generates an OTP response corresponding to the OTP request. The OTP response includes the audio signal having the speaker audio signal as a recording of the end-user's voice speaking the OTP text.

At operation 860, the computing device transmits the OTP response to the backend server. The computing device may provide additional information in the OTP response. The computing device may send types of information to the backend server in the OTP response, such as a timestamp of when the OTP text was spoken, the device ID or unique identifier of the computing device, geolocation data of the computing device, network information such as IP address and connection type, and additional metadata related to the audio signal or the computing device, among other potential types of information.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, attributes, or memory contents. Information, arguments, attributes, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-Ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A computer-implemented method for authentication using a voice-based one-time password (OTP), the method comprising:
transmitting, by a computing device associated with an end-user, a message indicating an operation request to a backend server;
receiving, by the computing device, an OTP request including an OTP prompt having OTP text of an OTP;
displaying, by the computing device, the OTP text of the OTP prompt at a user interface of the computing device of the end-user;
obtaining, by the computing device, an audio signal including a speaker audio signal of the end-user purportedly speaking the OTP;
generating, by the computing device, an OTP response corresponding to the OTP request, the OTP response including the audio signal including the speaker audio signal; and
transmitting, by the computing device, the OTP response to the backend server.

2. The method according to claim 1, further comprising receiving, by the computing device, an authentication result for the operation request from the backend server.

3. The method according to claim 2, further comprising displaying, by the computing device, the authentication result for the operation request as received from the backend server.

4. The method according to claim 1, wherein the OTP response further includes metadata associated with the computing device of the end-user, the metadata including at least one of a user identifier of the end-user or a device identifier of the computing device.

5. The method according to claim 1, wherein the OTP response further includes an operation request identifier associated with the operation request.

6. The method according to claim 1, wherein the computing device transmits the message indicating the operation request via at least one of a telephony channel or a data channel.

7. The method according to claim 1, wherein the computing device receives the OTP request via at least one of a data channel or a telephony channel.

8. The method according to claim 1, wherein the computing device transmits the OTP response via at least one of a data channel or a telephony channel.

9. The method according to claim 1, wherein the computing device includes and executes a mobile application associated with the backend server, and wherein the computing device receives the OTP request as a push notification for the mobile application.

10. The method according to claim 1, wherein the computing device receives the OTP request containing the OTP prompt via at least one of a text message or an email message.

11. A system for authentication using a voice-based one-time password (OTP), the system comprising:
a computing device associated with an end-user having at least one processor, the computing device configured to:
transmit a message indicating an operation request to a backend server;
receive an OTP request including an OTP prompt having OTP text of an OTP;
display the OTP text of the OTP prompt at a user interface of the computing device of the end-user;
obtain an audio signal including a speaker audio signal of the end-user purportedly speaking the OTP;
generate an OTP response corresponding to the OTP request, the OTP response including the audio signal including the speaker audio signal; and
transmit the OTP response to the backend server.

12. The system according to claim 11, wherein the computing device is further configured to receive an authentication result for the operation request from the backend server.

13. The system according to claim 12, wherein the computing device is further configured to display the authentication result for the operation request as received from the backend server.

14. The system according to claim 11, wherein the OTP response further includes metadata associated with the computing device of the end-user, the metadata including at least one of a user identifier of the end-user or a device identifier of the computing device.

15. The system according to claim 11, wherein the OTP response further includes an operation request identifier associated with the operation request.

16. The system according to claim 11, wherein the computing device transmits the message indicating the operation request via at least one of a telephony channel or a data channel.

17. The system according to claim 11, wherein the computing device receives the OTP request via at least one of a data channel or a telephony channel.

18. The system according to claim 11, wherein the computing device transmits the OTP response via at least one of a data channel or a telephony channel.

19. The system according to claim 11, wherein the computing device includes and executes a mobile application associated with the backend server, and wherein the computing device receives the OTP request as a push notification for the mobile application.

20. The system according to claim 11, wherein the computing device receives the OTP request containing the OTP prompt via at least one of a text message or an email message.
